(19) United States
(12) Patent Application Publication
(10) Pub. No.: US 2024/0417870 A1
(43) Pub. Date: Dec. 19, 2024

(54) COMPONENTS AND METHODS FOR THE ELECTROCHEMICAL REDUCTION OF GASEOUS CO2

(71) Applicant: THE GOVERNING COUNCIL OF THE UNIVERSITY OF TORONTO, Toronto (CA)

(72) Inventors: Cao-Thang DINH, Toronto (CA); Colin O'BRIEN, Toronto (CA); Christine GABARDO, Toronto (CA); Jonathan EDWARDS, Toronto (CA); Shijie LIU, Toronto (CA); Armin SEDIGHIAN RASOULI, Toronto (CA); Minh Triet LAM, Toronto (CA); Christopher MCCALLUM, Toronto (CA); Yen HOANG, Toronto (CA); David SINTON, Toronto (CA); Edward H. SARGENT, Toronto (CA)

(21) Appl. No.: 18/704,801

(22) PCT Filed: Oct. 26, 2022
(86) PCT No.: PCT/CA2022/051587

§ 371 Date: Apr. 25, 2024

Related U.S. Application Data
(60) Provisional application No. 63/263,036, filed on Oct. 26, 2021.

(51) Int. Cl. C25B 11/032; C25B 1/23; C25B 11/052

(52) U.S. Cl. CPC C25B 11/032; C25B 1/23; C25B 11/052

(57) ABSTRACT

A multiple-layer gas diffusion electrode for sustaining electrochemical reduction of gaseous CO₂ and/or CO into multi-carbon products is provided, including a gas diffusion layer comprising a support layer, a microporous layer having pores that are sized to maintain the gaseous CO₂ and/or CO, or a combination thereof available for electroreduction, and a catalytic layer comprising a catalyst favoring reduction of the CO₂ and/or CO. There are also provided, a method for producing the gas diffusion electrode, a spacer being positionable between an ion exchange membrane and an anode of a membrane electrode assembly, a reactor including a membrane electrode assembly and a support structure, a stack reactor that can include the gas diffusion electrode and the spacer as described herein, a method to diagnose and isolate at least one faulty repeat cell unit in an electrolyzer stack reactor, and a rinsing method for facilitating operation of an electroreduction system.

### TECHNICAL FIELD

The technical field generally relates to an electroreduction system for electrochemical conversion of gaseous CO₂, CO or a combination thereof into carbon products, and more particularly to specific components and assemblies of the electroreduction system that are designed to facilitate the electrochemical conversion, and to methods for manufacturing and operating such components and assemblies.

### BACKGROUND

Known electroreduction reactors include membrane electrode assemblies (MEAs) that have been designed for small scale operation (cell area<5 cm²). As reactors employing this technology grow in size, various challenges arise or remain to be solved.

For example, porous polytetrafluoroethylene (PTFE) filters can be used as porous support substrate in a cathode of the MEA, because of their hydrophobic properties, as described by Dinh et al. in “CO₂ electroreduction to ethylene via hydroxide-mediated copper catalysis at an abrupt interface” Science. 2018 May 18; 360(6390):783-787. However, PTFE is not electrically conductive, which can cause a lack of current conduction and lead to a large in-plane resistance (i.e., along the face of the electrode) and cell voltage drop, especially in larger current cells (>80 A per cell).

In another example, the stability of an ion exchange membrane in the MEA is critical, and membranes can fail due to mechanical instabilities caused by mechanical punctures, local heating, drying, chemical degradation, etc. The current state-of-the-art solutions in the field are to use reinforced membranes; however, these reinforced membranes offer increased cell voltages, poorer membrane-electrode contact, and degrade over time.

In another example, as reactors employing MEA grow in size (>5 cm²), serpentine channels can be used to better control reactant and product flows along the surface of the MEA. In this approach, unsupported channel regions can suffer from reduced electrical contact with the flow field/current collector or distributor, and mechanical instability in the MEA. In addition, the cathode/anode area directly above the land areas of the flow field can experience decreased mass transport since species must diffuse a far distance from the channel to reach these areas and vice versa. This reduced mass transport results in limited access to CO₂/CO reactant gas which harms the reaction efficiency. Moreover, decreased convective effects can be observed, leading to the production of hot zones and resulting in uneven heat distribution. Due to the heat emitted from the reaction, these areas are likely to reach higher temperatures which can damage the MEA and/or electrolyzer components.

In another example, during operation of known MEA, cations that migrate through the ion exchange membrane during CO₂ electroreduction can form solid salts with the bicarbonate or carbonate anions on the cathode side (cathodic compartment) of a CO₂ electrochemical reactor. Once the cathodic compartment and porous structures of the cathode get filled with solid salt, the CO₂ is not able to reach the catalyst, the reduction reaction of CO₂ stops, and no new CO₂ reduction product is produced.

In another example, commercially available CO₂ electrolyzer reactors are typically limited to small areas (5 cm²) and single cell design. Such reactors are useful for testing catalysts and reaction conditions at the lab scale, but if industrially meaningful conversion rates are to be realized, both the cell size and quantity need to be increased. Once combined, any defects in a single cell will have impacts on the overall performance.

There is thus still a need for various improvements in the field of electroreduction of CO₂ or CO at an industrial scale.

### SUMMARY

In one aspect, there is provided a multiple-layer gas diffusion electrode (GDE) for sustaining electrochemical reduction of gaseous CO₂, CO, or a combination thereof into multi-carbon products, the multiple-layer gas diffusion electrode comprising
a gas diffusion layer (GDL) comprising:
   a support layer;
   a microporous layer (MPL) having pores that are sized to maintain the gaseous CO₂, CO, or a combination thereof available for electroreduction; and
a catalytic layer comprising a catalyst favoring reduction of the CO₂, CO or the combination thereof,
   wherein each one of the support layer and the MPL is hydrophobic and electrically conductive, and the GDE being electrically conductive from one layer to another.

In some implementations, the support layer comprises a first conductive material and a first hydrophobic polymer. For example, the first conductive material can be a carbon paper, a carbon felt, a carbon cloth, or a metal mesh. For example, the first hydrophobic polymer can be PTFE. The support layer can have a first hydrophobic polymer content between 5 wt % and 60 wt %. Optionally, the first hydrophobic polymer content can be between 30 wt % and 50 wt %.

In some implementations, the support layer can have a thickness between 50 μm and 1000 μm. Optionally, the thickness of the support layer can be between 100 μm and 300 μm.

In some implementations, the MPL can include a second conductive material and a second hydrophobic polymer. For example, the second hydrophobic polymer can be PTFE. For example, the second conductive material can include porous particles. Optionally, the second conductive material can consist of or include carbon nanoparticles. Further optionally, the second conductive material can include acetylene black, ketjen black, carbon black, carbon nanotubes, graphite, graphene, or any combinations thereof. The MPL can have a second hydrophobic polymer content between 60 wt % and 99 wt %, and optionally the second hydrophobic polymer content being between 80 wt % and 95 wt %.

In some implementations, the MPL has an MPL thickness between 0.5 and 500 μm. Optionally, the MPL thickness can be between 10 and 80 μm.

In some implementations, the catalyst can be provided as particles, and the catalytic layer further comprises a binder that binds the catalyst particles, and facilitates ionic conductivity and CO₂ availability to the catalyst particles. For example, the binder can be an ionomer or PTFE. For example, the ionomer can be Nafion®, Fumion®, or analogs thereof.

In some implementations, the catalyst particles are of a metal, a metal oxide or a mixed metal. For example, the catalyst particles can be nanoparticles. The catalyst particles can have a size between 1 nm and 10000 nm. Optionally, the size of the catalyst nanoparticles can be between 10 nm and 100 nm. In addition, the catalytic layer can have a thickness of at most 10 μm.

In some implementations, the multiple-layer GDE can further comprise a stabilization layer comprising solid particles having a surface that is modified with a functionalizing group to prevent the catalytic layer from reconstructing during operation of the multiple-layer gas diffusion electrode. For example, the solid particles of the stabilization layer can be particles of carbon, graphite, graphene, TiO₂, SiO₂, ceria, or any combination thereof. The solid particles can have a particle size between 1 nm and 1 μm. The solid particles can have a particle size between 10 nm and 100 nm. For example, the functionalizing group can be an ionized unit, imidazolium, sulfonic acid, poly(aryl piperidinium) of an ion-conducting ionomer. Optionally, the ion-conducting ionomer can be Nafion®, Fumion®, or an analog thereof. In addition, the stabilization layer can have a thickness of at most 10 μm.

In another aspect, there is provided a method for producing a gas diffusion electrode (GDE) comprising a gas diffusion layer (GDL) and a catalytic layer. The method includes:
providing a hydrophobic and conductive support layer;
blade coating a microporous layer ink on the support layer, the microporous layer ink comprising conductive particles and a hydrophobic polymer to form a microporous layer (MPL);
heat treating the MPL to sinter the hydrophobic polymer within a network of the conductive particles and form the GDL;
spraying a catalyst ink comprising catalyst particles and a binder onto the GDL to form the catalytic layer.

In some implementations, the method can comprise forming the catalyst ink by mixing the catalyst particles, the binder and a solvent.

In some implementations, the catalyst particles can be copper nanoparticles and the binder is an ionomer.

In some implementations, the blade coating can include producing the MPL with a thickness between 0.5 μm and 500 μm.

In some implementations, the heat treating of the MPL can include heating the GDL at a temperature between 30° and 400° C.

In some implementations, the GDE can further include a stabilization layer comprising solid particles having a surface that is modified with a functionalizing group, and the method can further comprise spraying a stabilization ink comprising the solid particles and a binder onto the catalytic layer. Optionally, the method can include forming the stabilization ink by mixing the solid particles, the binder and a solvent. For example, the solid particles can be carbon nanoparticles and the binder can be an ion-conducting polymer.

In another aspect, there is provided a spacer positionable between an ion exchange membrane and an anode of a membrane electrode assembly, the spacer comprising a hydrophilic, porous and non-conductive layer.

In some implementations, the hydrophilic, porous and non-conductive layer can be made of polyester, rayon, silk, cotton, cheesecloth, PES, nylon, hydrophilic PTFE, cellulose, polypropylene, polyethylene, or any combinations thereof.

In some implementations, the hydrophilic, porous and non-conductive layer can be made of woven fabric fibers. For example, the woven fabric fibers can be synthetic fabric fibers.

In some implementations, the spacer can include a coating of an ionomer onto the hydrophilic, porous and non-conductive layer.

In some implementations, the spacer can have a thickness between 0.001 mm and 3 mm. Optionally, the thickness of the spacer can be between 100 μm and 400 μm.

In some implementations, the hydrophilic, porous and non-conductive layer can have a porosity of 10% to 90%. For example, the hydrophilic, porous and non-conductive layer can have pores having a pore size between 0.0001 mm and 1 mm. Optionally, the pore size can be between 10 and 100 μm.

In another aspect, there is provided a membrane electrode assembly for electroreduction of CO₂, CO, or a mixture thereof into carbon products. The membrane electrode assembly includes:
a cathode,
an anode,
an ion exchange membrane positioned between the cathode and the anode, with the ion exchange membrane being in contact with the cathode; and
a spacer positioned between the ion exchange membrane and the anode, the spacer comprising a hydrophilic, porous and non-conductive layer, and the spacer having one side in contact with the ion exchange membrane and another side in contact with the anode.

In some implementations, the spacer can be adhered to, fastened to, hot-pressed (electrode), placed against, or pressed against the anode and/or the ion exchange membrane.

In some implementations, the membrane electrode assembly can have a lifetime enhancement of at least 100%, of at least 1000%, or of at least 2000% in comparison with a membrane electrode assembly being exempted of the spacer.

In some implementations, the spacer can further include at least one feature described herein.

In some implementations, the cathode of the membrane electrode assembly can be a gas diffusion electrode as described herein.

In another aspect, there is provided a reactor for operating electroreduction of CO₂, CO, or a mixture thereof into carbon products. The reactor includes:
a membrane electrode assembly comprising a cathode, an anode and an ion exchange membrane, and
a support structure comprising a pair of opposed support substructures, each support substructure contacting one side of the membrane electrode assembly to uniformly maintain the membrane electrode assembly in between the pair of opposed support substructures;
wherein each support substructure comprises at least one layer of a porous and electrically conductive material to ensure flow of reactants, products, electrolyte and electrons to or from the anode and the cathode of the membrane electrode assembly.

In some implementations, each support substructure can be welded to, adhered to, fastened to, hot-pressed or pressed against the cathode or the anode of the membrane electrode assembly.

In some implementations, the porous and electrically conductive material can include titanium, copper, aluminum, stainless steel, bronze, brass, galvanized steel, platinum, nickel, carbon, carbon steel, iron, lead or any combinations thereof.

In some implementations, the porous and electrically conductive material can be a metal that avoids catalyzing hydrogen evolution reaction (HER).

In some implementations, the porous and electrically conductive material can be a metal that is resistant to corrosion.

In some implementations, the porous and electrically conductive material can be a metal that is resistant to hydrogen embrittlement.

In some implementations, the membrane electrode assembly can have an active surface having a size of at least 100 cm².

In some implementations, the support substructure in contact with the cathode of the membrane electrode assembly is the cathodic support substructure, and the cathodic support substructure can consist of a single layer of the porous and electrically conductive material. For example, the cathodic support substructure can have a thickness between 200 and 1300 microns. Optionally, the thickness of the cathodic support substructure is between 600 and 900 microns. For example, the single layer of the cathodic support substructure can have pores having a pore size ranging between 1 mm and 10 mm, optionally between 5 and 7 mm. For example, the single layer of the cathodic support substructure can be made of titanium, copper, aluminum, stainless steel, or a combination thereof.

In some implementations, the support substructure in contact with the anode of the membrane electrode assembly is the anodic support substructure, and the anodic support substructure can consist of multiple layers of a porous, electrically conductive and anti-corrosive material. For example, the anodic support substructure can comprise at least two layers. Optionally, the anodic support substructure can comprise at least four layers. For example, each one of the multiple layers of the anodic support substructure can be made of titanium. For example, the anodic support substructure can have a thickness between 500 and 3000 microns. Optionally, the thickness of the anodic support substructure can be between 1000 and 2000 microns. For example, each layer of the anodic support substructure can have pores having a pore size ranging between 1 and 10 mm, optionally between 3 and 7 mm.

In some implementations, the support structure can further comprise a turbulence enhancer that is added to at least one of the support substructures.

In some implementations, the reactor can further comprise a cathodic flow field provided in contact with one support substructure of the pair of opposed support substructures, and an anodic flow field provided in contact with the other support substructure of the pair of opposed support substructures.

In some implementations, the cathode of the membrane electrode assembly can be a gas diffusion electrode as described herein.

In some implementations, the membrane electrode assembly can further include at least one feature described herein.

In another aspect, there is provided a method for facilitating operation of an electroreduction system converting CO₂, CO or a mixture thereof into carbon products. The method includes:
injecting the CO₂, CO or the mixture thereof into an inlet of a cathodic compartment of the electroreduction system to perform electroreduction of the CO₂, CO or the mixture thereof into the carbon products, the electroreduction comprising forming carbonate salts in the cathodic compartment along a flow path;
injecting a rinsing fluid into the inlet of the cathodic compartment to dissolve and remove at least a portion of the carbonate salts along the flow path to form a salt-enriched fluid; and
recovering at least one of the carbon products and the salt-enriched fluid from an outlet of the cathodic compartment.

In some implementations, the injection of the rinsing fluid can be performed in alternance with the injection of the CO₂, CO or the mixture thereof. Alternatively, the injection of the CO₂, CO or the mixture thereof can be maintained during the injection of the rinsing fluid.

In some implementations, the rinsing fluid can be water, deionized water, a mixture of water and a surface tension reducing molecule, or waste electrolyte.

In some implementations, the injection of the rinsing fluid is periodically performed during a rinsing period. For example, the rinsing period can have a duration between 20 s and 30 min. Optionally, the duration of the rinsing period can be between 1 and 3 min.

In some implementations, a ratio of a volumetric flow rate of rinsing fluid to that of the CO₂, CO or the mixture thereof can be between 0.05 and 0.5.

In some implementations, the injection of the rinsing fluid can be performed with a ratio of the volumetric flow rate of the rinsing fluid to a volume of the cathodic compartment between 20 and 200 per minute. Optionally, the ratio of the volumetric flow rate to the volume of the cathodic compartment can be between 50 and 80 per minute.

In some implementations, the injection of the rinsing fluid can be performed at a rinsing frequency between 30 min to 12 hours. Optionally, the rinsing frequency can be between 1 hour and 3 hours.

In some implementations, the method can include providing a membrane electrode assembly as described herein or a reactor as described herein as part of the electroreduction system, wherein the cathodic compartment is included in the membrane electrode assembly.

In another aspect, there is provided an electroreduction system converting CO₂, CO or a mixture thereof into carbon products. The system includes:
a cathodic compartment comprising a gas diffusion electrode that sustains electroreduction of the CO₂, CO or the mixture thereof, and an inlet in fluid communication with the gas diffusion electrode; and
a distribution assembly comprising:
   a first supply piping in fluid communication with a source of the CO₂, CO or the mixture thereof, and supplying the CO₂, CO or the mixture thereof into the inlet of the cathodic compartment, to perform electroreduction of the CO₂, CO or the mixture thereof into the carbon products, the electroreduction comprising forming carbonate salts along a flow path in the cathodic compartment;
   a second supply piping in fluid communication with a source of a rinsing fluid;
   a valve that is actuable to fluidly connect the inlet of the cathodic compartment to the second supply piping for injecting the rinsing fluid into the inlet of the cathodic compartment, thereby dissolving and removing at least a portion of the carbonate salts along the flow path to form a salt-enriched fluid; and
   a pump that is actuable to control a volumetric flow rate of the rinsing fluid to the cathodic compartment.

In some implementations, the system can further comprise a controller that is operatively connected to the valve and the pump for automatic actuation thereof, to periodically trigger injection of the rinsing fluid at a rinsing frequency and for a rinsing period. For example, the rinsing period can have a duration between 20 s and 30 min. Optionally, the duration of the rinsing period can be between 1 and 3 min. For example, the rinsing frequency can be between 30 min to 12 hours. Optionally, the rinsing frequency can be between 1 and 3 hours.

In some implementations of the system, a ratio of the volumetric flow rate of the rinsing fluid via the second supplying piping to that of the CO₂, CO or the mixture thereof via the first supply piping can be between 0.05 and 0.5.

In some implementations, the system can further comprise a rinsing fluid reservoir being the source of the rinsing fluid, and a waste collection tank receiving the recovered salt-enriched fluid.

In some implementations of the system, the rinsing fluid can be water, deionized water, a mixture of water and a surface tension reducing molecule, or waste electrolyte.

In some implementations of the system, the cathodic compartment can further comprise a cathodic flow field and a porous mesh support substructure for contacting the gas diffusion electrode comprising a catalyst, and being in fluid communication with one another to define the flow path.

In some implementations of the system, the cathodic compartment can be part of a membrane electrode assembly as described herein, or of the reactor (stack or not) as described herein.

In another aspect, there is provided an electrolyzer stack reactor for reduction of CO₂, CO or a mixture thereof into carbon products. The electrolyzer stack reactor includes:
a pair of end plates, the pair of end plates comprising a proximal end plate and a distal end plate;
multiple repeat cell units positioned between the proximal end plate and the distal end plate, each repeat cell unit comprising:
   a cathodic flow field having a cathodic inlet and a cathodic outlet;
   an anodic flow field having an anodic inlet and anodic outlet, and
   a membrane electrode assembly positioned between the cathodic flow field and the anodic flow field;
a manifold assembly to distribute the CO₂, CO or the mixture thereof and the carbon products to or from each repeat cell unit in parallel, the manifold assembly comprising:
   a cathodic inlet manifold branched to the cathodic inlet of each repeat cell unit to distribute the CO₂, CO or the mixture thereof to the membrane electrode assembly via the cathodic flow field,
   an anodic inlet manifold branched to the anodic inlet of each repeat cell unit to distribute an anolyte to the membrane electrode assembly via the anodic flow field,
   a cathodic outlet manifold branched to the cathodic outlet of each repeat cell unit to release the carbon products from the membrane electrode assembly via the cathodic flow field, and
   an anodic outlet manifold branched to the anodic outlet of each repeat cell unit to release used anolyte from the membrane electrode assembly via the anodic flow field; and
a pair of busbars extending across the multiple repeat cell units, and comprising:
   an anodic busbar electrically connecting the anodic flow field of each one of the multiple repeat cell units in parallel, and
   a cathodic busbar electrically connecting the cathodic flow field of each one of the multiple repeat cell units in parallel.

In some implementations, the cathodic inlet can be located at a top of the at least one repeat cell unit, and the anodic inlet can be located at a bottom of the at least one repeat cell unit.

In some implementations, the anolyte and the CO₂, CO or the mixture thereof can be co-currently flowing within the anode inlet manifold and the cathode inlet manifold respectively. Alternatively, the anolyte can be flowing within the anode inlet manifold counter-currently to the CO₂, CO or the mixture thereof flowing in the cathode inlet manifold.

In some implementations, each of the anode inlet manifold and cathode inlet manifold can include an inlet port defined in both the proximal end plate and the distal end plate.

In some implementations, each of the anode outlet manifold and cathode outlet manifold can include an outlet port defined in both the proximal end plate and the distal end plate.

In some implementations, the cathode inlet and outlet manifolds and the anode inlet and outlet manifolds are branched to the respective cathodic and anodic inlets and outlets via a tubing or header extending externally from the multiple repeat cell units. Alternatively, the cathode inlet and outlet manifolds and the anode inlet and outlet manifolds can be branched to the respective cathodic and anodic inlets and outlets via inner inlet and outlet ports that are internally defined within a housing of each anodic and cathodic flow field of the multiple repeat cell units. Further alternatively, the cathode inlet and outlet manifolds can be branched to the respective cathodic inlets and outlets internally, whereas the anode inlet and outlet manifolds can be branched to respective anodic inlets and outlets externally, and vice versa.

In some implementations, the multiple repeat cell units can comprise 2 to 10000 repeat cell units.

In some implementations, the electrolyzer stack reactor can comprise a plurality of fuses, each fuse connecting in series at least one of the anodic busbar and the cathodic busbar to a corresponding repeat cell unit.

In some implementations, at least one repeat cell unit can comprise at least one porous support substructure having one side in contact with the membrane electrode assembly and another side in contact with the anodic flow field or cathodic flow field. For example, the at least one porous support substructure can be made of at least one metallic mesh layer.

In some implementations, the at least one repeat unit can have a cell area between 100 cm² and 1000 cm².

In some implementations, the membrane electrode assembly of each repeat cell unit further includes at least one feature as described herein.

In some implementations, the cathode of each repeat cell unit is a gas diffusion electrode as described herein.

In some implementations, each repeat cell unit is an electrolyzer reactor as described herein.

In another aspect, there is provided a method to diagnose and isolate at least one faulty repeat cell unit in an electrolyzer stack reactor comprising a proximal end plate and a distal end plate, and a plurality of repeat cell units positioned between the proximal end plate and the distal end plate, the method comprising:
electrically connecting each cathode of the plurality of repeat cell units in parallel to a cathodic busbar;
electrically connecting each anode of the plurality of repeat cell units in parallel to an anodic busbar;
fluidly connecting each cathode of the plurality of repeat cell units in parallel to a cathode manifold assembly for distributing CO₂, CO or a mixture thereof and recovering carbon products;
fluidly connecting each anode of the plurality of repeat cell units in parallel to an anode manifold assembly for distributing an anolyte and recovering used anolyte;
monitoring an electrical current of each repeat cell unit to detect potential faulty operation of at least one repeat cell unit; and
when the at least one faulty repeat cell unit is detected, bypassing the faulty repeat cell unit by fluidly and/or electrically disconnecting the at least one faulty repeat cell unit from the adjacent repeat cell units.

In some implementations, the method can include monitoring a voltage of the electrolyzer stack reactor to detect a short circuit when the monitored voltage decreases.

In some implementations, the method can include providing the electrolyzer stack reactor further comprising at least one feature described herein.

For example, electrically disconnecting the at least one faulty repeat cell unit can be performed via breaking of a fuse that is connected in series with the faulty repeat cell unit.

While the present techniques and components will be described in conjunction with example implementations, it will be understood that it is not intended to limit their scope to such implementations. On the contrary, it is intended to cover all alternatives, modifications and equivalents as may be included as defined by the present description. The objects, advantages and other features of the present techniques and components will become more apparent and be better understood upon reading of the following non-restrictive description of the invention, given with reference to the accompanying drawings.

### BRIEF DESCRIPTION OF THE DRAWINGS

FIG. 1 is a schematic of a cross-sectional view of an electroreduction reactor as encompassed herein, including a cathodic flow field and an anodic flow field, a membrane electrode assembly positioned between the cathodic flow field and the anodic flow field, and two support plates, with each support plate being sandwiched between the MEA and a flow field.

FIG. 2 is a schematic of the layers of the gas diffusion layer

FIG. 3 is a schematic of the blade coating method for the gas diffusion layer.

FIG. 4 is a graph showing selectivity (Faradaic Efficiency (%)) for H₂ of a 5-cm² cathode including four commercial gas diffusion layers (GDL240 referring to a CeTech GDL240™, H23C8 referring to Freudenberg H23C8™, GDS2230 referring to AvCarb GDS2230™, and 25BC referring to Sigracet 25BC™) and a custom cathode as encompassed herein at a current density of 200 mA/cm².

FIG. 5 is a graph showing selectivity (Faradaic Efficiency (%)) for H₂, CO and C₂H₄, of a 5-cm² cathode including the gas diffusion layer as proposed herein at a current density of 200 mA/cm².

FIG. 6 is a graph showing selectivity (Faradaic Efficiency (%)) for H₂, CO and C₂H₄, of 5-cm² cathodes including different gas diffusion layers (GDL)s at 200 mA/cm², the best results for ethylene being obtained with a GDL as proposed herein including a support layer and a hydrophobic/microporous layer including carbon nanoparticles and PTFE.

FIGS. 7 to 9 are graphs showing selectivity (Faradaic Efficiency (%)) for H₂, CO and C₂H₄, of 5-cm² cathodes including a microporous layer having three different thicknesses at applied current densities of 200 mA/cm² (FIG. 7), 300 mA/cm² (FIG. 8), and 400 mA/cm² (FIG. 9).

FIG. 10 is a graph showing Faradaic Efficiency (in %) for H₂, CO and C₂H₄, and cell voltage (in V) vs. materials chosen as a hydrophobic, porous and non-conductive layer of a spacer in a membrane electrode assembly, and when the membrane electrode assembly does not include any spacer.

FIG. 11A is a graph showing Faradaic Efficiency (in %) for H₂, CO and C₂H₄, and cell voltage (in V) vs. time (in hours) for a membrane electrode assembly not including a spacer.

FIG. 11B is a graph showing Faradaic Efficiency (in %) for H₂, CO and C₂H₄, and cell voltage (in V) vs. time (in hours) for a membrane electrode assembly including a spacer.

FIG. 12 is a graph showing Faradaic Efficiency (in %) for H₂, CO and C₂H₄, and cell voltage (in V) vs. materials chosen as a hydrophobic, porous and non-conductive layer of a spacer in a membrane electrode assembly, the absence of spacer or the presence of an ionomer coated spacer.

FIG. 13 is a schematic of a cross-sectional view of a portion of an electroreduction reactor as encompassed herein including a cathodic flow field and an anodic flow field, a membrane electrode assembly positioned between the cathodic flow field and the anodic flow field, and two support substructures of layered metallic mesh, with each support substructure being sandwiched between the MEA and a flow field.

FIG. 14 is a graph showing voltage distribution in the cathode flow field in absence of a mesh support substructure.

FIG. 15 is a graph showing voltage distribution in the cathode flow field in presence of a one-layer mesh support substructure.

FIG. 16 includes two graphs showing CO₂/CO mass transfer in the cathode flow field in absence of a mesh support substructure: the left graph shows the CO₂ concentration (in mol/m³) in two adjacent flow field channels and land areas around them. The right graph shows the normalized CO concentration (normalized by the total concentration of the stream, 41.6 mol/m³) when looking at a cross-sectional view of the cathode (the ion exchange membrane being on the bottom face and a flow field channel being at the top face of the cathode).

FIG. 17 is a graph showing a normalized CO concentration when looking at a cross-sectional view of the cathode (the ion exchange membrane being on the bottom face and a flow field channel being at the top face of the cathode in presence of a four-layer mesh support substructure).

FIG. 18 is a graph showing selectivity (Faradaic Efficiency (%)) for H₂, CO and C₂H₄, of an 800-cm² cathode at an applied current density of 100 mA/cm² with and without the presence of a mesh support substructure between the cathode and the cathode flow field.

FIG. 19 is a graph showing selectivity (Faradaic Efficiency (%)) for H₂, CO and C₂H₄, of an 800-cm² cathode vs. an applied current density in mA/cm² and in absence of a mesh support substructure.

FIG. 20 is a graph showing selectivity (Faradaic Efficiency (%)) for H₂, CO and C₂H₄, of an 800-cm² cathode vs. an applied current density in mA/cm² and in presence of a one-layer titanium mesh support substructure.

FIG. 21 is a graph showing selectivity (Faradaic Efficiency (%)) for H₂, CO and C₂H₄, of an 800-cm² cathode vs. time (in days), the cathode being supported by three layers of a diamond-shape titanium mesh with a pore size within the 0.050 to 0.150 inches range.

FIG. 22 is a graph showing selectivity (Faradaic Efficiency (%)) for H₂, CO and C₂H₄, of an 800-cm² cathode vs. time (in days), the cathode being supported by one layer of a large diamond-shape titanium mesh with a pore size within the 0.100 to 0.300 inches range.

FIG. 23 is a graph showing selectivity (Faradaic Efficiency (%)) for H₂, CO and C₂H₄, of an 800-cm² cathode vs. time (in days), the cathode being supported by one layer of a copper mesh.

FIG. 24 is a top perspective view of an electrolyzer stack reactor as encompassed herein.

FIG. 25 is a top perspective exploded view of components of an anodic flow field (and current collector) assembly, including a housing with internal anode inlet and outlet manifolds and an anodic flow filed (and current collector) insert.

FIG. 26 is a top perspective view of an anodic flow field (and current collector) assembly, including ports for connection to an external manifold assembly and an anodic flow filed (and current collector) insert, being combined as a single piece.

FIG. 27 is a front view of a cathodic flow field assembly.

FIG. 28 is a front view of an anodic flow field (and current collector) assembly.

FIG. 29 is a top view of the electrolyzer stack reactor of FIG. 24.

FIG. 30 is a top perspective exploded view of components of the electrolyzer stack reactor as encompassed herein, including multiple repeat cell unit that can be designed as the electroreduction reactor schematized in FIG. 1.

FIG. 31 is a simplified process flow diagram of a rinsing operation of an electrolyzer reactor including at least one membrane electrode assembly sustaining electroreduction of CO, CO₂ or a mixture thereof.

FIG. 32 is a schematic of an inlet flow and an outlet flow to and from an electrolyzer reactor including at least one membrane electrode assembly sustaining electroreduction of CO, CO₂ or a mixture thereof.

FIG. 33 includes two graphs showing current (in A), voltage (in V) and CO₂ flow (in kg/hr) vs time during which a valve of a rinsing system is switched from the closed position to the open position.

FIG. 34 is a graph showing selectivity (Faradaic Efficiency (%)) for H₂, CO and C₂H₄ before and after rinsing (stripes).

FIG. 35 is a graph showing selectivity (Faradaic Efficiency (%)) for H₂, CO and C₂H₄ vs time (in hours) when no rinsing operation is performed onto the electrolyzer reactor.

FIG. 36 is a graph showing selectivity (Faradaic Efficiency (%)) for H₂, CO and C₂H₄ vs time (in hours) when a rinsing operation is performed onto the electrolyzer reactor.

FIG. 37 is a graph showing selectivity (Faradaic Efficiency (%)) for H₂, CO and C₂H₄, and cell voltage (in V) vs. time (in hours) when a rinsing operation is performed onto the electrolyzer reactor with a rinsing frequency of 118 minutes.

FIG. 38 is a graph showing selectivity (Faradaic Efficiency (%)) for H₂, CO and C₂H₄, and cell voltage (in V) vs. time (in hours) when a rinsing operation is performed onto the electrolyzer reactor with a rinsing frequency of 68 minutes.

### DETAILED DESCRIPTION

The present techniques relate to the design of components of an electroreduction system that facilitates electrochemical conversion of gaseous CO₂, CO, or a combination thereof into carbon products. There is provided a multiple-layer gas diffusion electrode that can be used as a cathode for sustaining electrochemical reduction of gaseous CO₂, CO, or a combination thereof into the carbon products. Each layer of the multiple-layer gas diffusion electrode can be designed to be hydrophobic and electrically conductive, as will be described in detail further below. More particularly, the multiple-layer gas diffusion electrode can be part of a membrane electrode assembly (MEA), further comprising an anode and an ion exchange membrane (IEM) that separates the cathode from the anode. For example, the ion exchange membrane can be an anionic exchange membrane (AEM), a cationic exchange membrane (CEM), or a bipolar membrane (BPM). There is further provided a hydrophilic spacer that can be part of the MEA and can be positioned between the IEM and the anode, as will be described in detail further below. In addition, the MEA can be part of an electroreduction reactor (also referred to as an electrochemical flow cell reactor, an MEA electrolyzer, or an electrolyzer reactor) that further comprises a cathodic flow field to feed the gaseous CO₂, CO, or a combination thereof to a cathode side of the MEA, and an anodic flow field to feed an anolyte to an anode side of the MEA. There is further provided an electroreduction reactor that further includes a support structure comprising a pair of opposed porous and electrically conductive support plates, each support plate being provided between the MEA and the flow field (anodic or cathodic), to uniformly maintain the MEA in between the pair of opposed support plates, as will be described in detail further below. There is further provided an electroreduction system that includes the electroreduction reactor and additional components, such as a distribution assembly including supply piping, and at least one valve to distribute the required fluids (gaseous CO₂/CO, anolyte, or rinsing fluid) to the electroreduction reactor, as will be described in detail further below. The electroreduction reactor can be further used as at least one repeat cell unit from a plurality of repeat cell units that are stacked between a proximal end plate and a distal end plate to form an electrolyzer stack reactor, as will be described in detail further below.

The carbon products that can be produced via the present system, method and process implementations include single carbon products, multi-carbon products, or a combination thereof. More particularly, the carbon products can for example include carbon monoxide, formate (formic acid), methane, ethylene, acetate (acetic acid), ethanol, n-propanol, acetaldehyde, and propionaldehyde.

Several methods are further encompassed herein and relate to the manufacture, use or maintenance of the components, units and assemblies of the overall electroreduction system. For example, operation of the electroreduction reactor can be facilitated by periodically rinsing a cathodic compartment of the MEA to dissolve and remove at least a portion of carbonate salts that can form during electroreduction of the gaseous CO₂, CO, or the combination thereof in the cathodic compartment.

Gas diffusion electrode with a composite hydrophobic conductive porous support and hydrophobic microporous layer for electrochemical CO₂ and/or CO reduction

Gas diffusion layers (GDLs) have recently been incorporated as cathode materials into electrochemical flow cell reactors for CO₂/CO reduction to greatly increase efficiency and current density. By providing gaseous CO₂/CO in close proximity to the catalyst, the CO₂/CO can diffuse to active catalyst sites much more readily than in completely aqueous reactors (H-cells) and can react at high current densities (several hundred mA per cm²). Hydrophobicity of the cathode in CO₂RR is necessary to avoid flooding with liquid electrolyte and products.

On the lab-scale, porous polytetrafluoroethylene (PTFE) filters are known to be effective cathode substrates because of their hydrophobic properties. However, the PTFE filters are not electrically conductive and when they are used as a gas diffusion layer, all the current is conducted across the plane of the catalyst layer. This strategy is possible with currents less than 1 A but would not be sufficiently electrically conductive for currents reached in larger current cells (>80 A per cell).

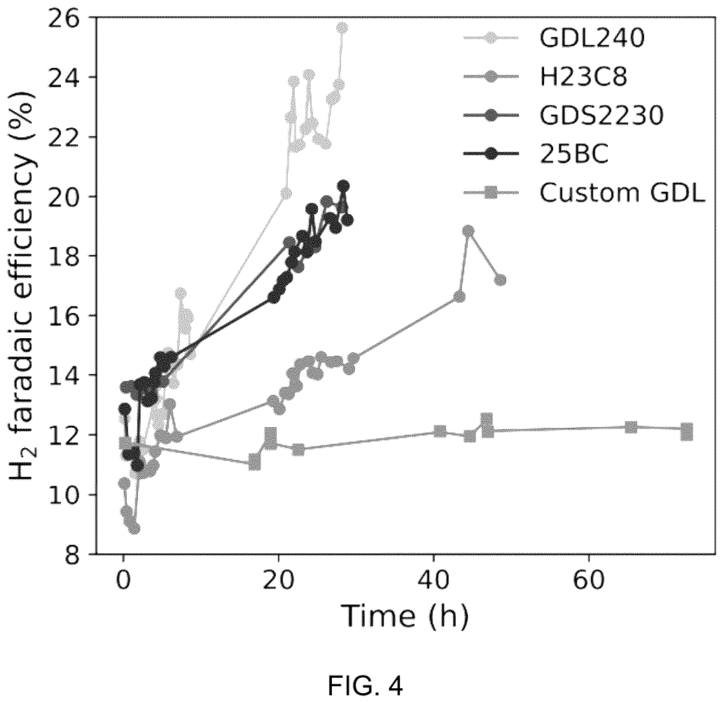

Other known commercial GDLs are usually composed of a porous carbon fiber paper (0-5% wet-proofing) or felt covered with a microporous layer (composed of a mix of carbon nanoparticles and 5-30% polytetrafluoroethylene (PTFE)). A nanoparticle catalyst is further typically deposited on the surface of the GDL to form a gas diffusion electrode (GDE). However, referring to FIG. 4, it was shown that the hydrophobicity of these known GDL typically decreases over time as the carbon materials become more hydrophilic through the electroreduction process. The decrease in hydrophobicity can be due to electro-wetting, the formation of salt crystals, or the deposition of impurities on the surface of the GDL. This loss of hydrophobicity leads to the GDL being flooding with water, electrolyte, or liquid products, which limits the diffusion of CO/CO₂ to the catalyst layer and eventually causes reaction instability. These electrodes are thus found not to be suitable for use in CO₂ MEA electrolyzers that produces carbon products at high current density over the period of hundreds of hours.

There is proposed herein an electrode, e.g., a cathode, including a gas diffusion layer that remains hydrophobic for extended periods and prevents flooding from the electrolyte and products, while being electrically conductive. More particularly, the use of the cathode as proposed herein increases the duration, e.g., from at most 10 hours of operation to several hundred hours as seen in FIG. 4, for which a CO₂/CO electrolyzer can be run before the gas diffusion layer is no longer capable of providing CO₂/CO to the catalyst, due to blockage from being filled with formed salt crystals or flooded with electrolyte or products.

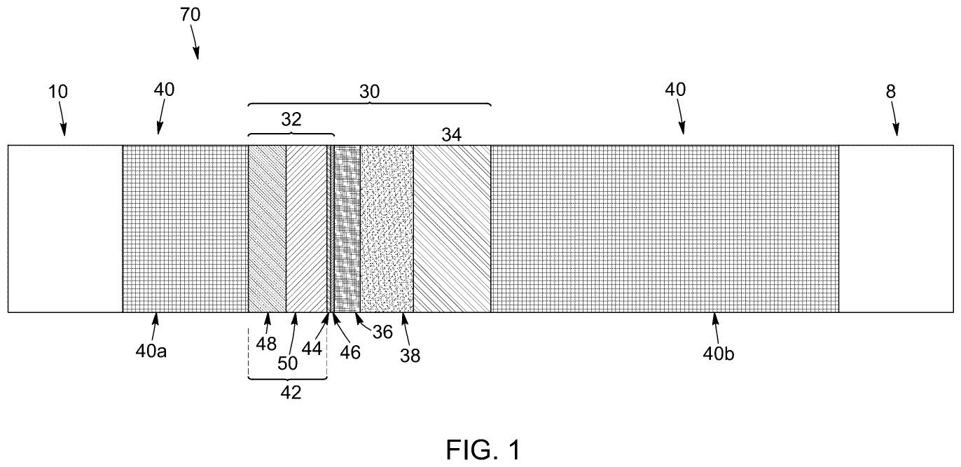

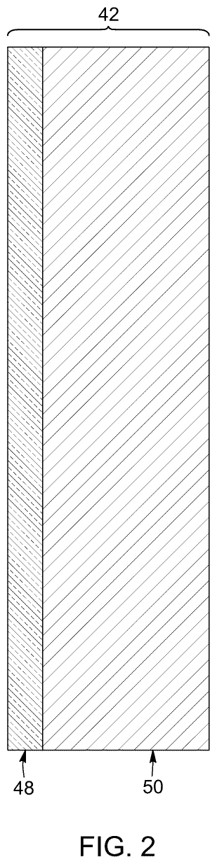

Referring to FIG. 1, the cathode 32 as proposed herein is a GDE comprising a GDL 42, a catalyst layer 44, and optionally a stabilization layer 46. Referring to FIGS. 1 and 2, the GDL 42 includes a support layer 48, and a microporous layer (MPL) 50 deposited on the support layer 48. In some implementations, the support layer can include carbon paper, carbon felt, or carbon cloth. Alternatively, the support layer can include a metal, e.g., a metal mesh. The support layer is porous with a sub-millimeter pore size. The MPL is designed to be hydrophobic and conductive. The MPL can include conductive nanoparticles, such as carbon nanoparticles. Optionally, the carbon nanoparticles can be or include acetylene black, ketjen black, carbon black, carbon nanotubes, graphite, graphene, or any combinations thereof. The MPL can further include a hydrophobic polymer. For example, the hydrophobic polymer can be PTFE, fluorinated ethylene propylene (FEP), perfluoroalkoxy (PFA), polyvinylidene fluoride (PVDF), and polydimethylsiloxane (PDMS).

More particularly, after testing different substrate materials, the produced GDL and resulting GDE are hydrophobic and provide through-plane electrical conductivity. Through-plane conductivity is to be understood as conduction of electricity from one layer to another adjacent layer of the GDL or cathode (GDE).

In some implementations, the support layer of the cathode can be a thin commercial carbon paper treated with a custom PTFE-containing layer, e.g., 5 wt % to 60 wt %, optionally at least 30 wt %, further optionally between 30 wt % and 50 wt % of PTFE. The resulting treated carbon paper (support layer) has a thickness between 50 μm and 1000 μm, optionally between 100 μm and 300 μm. In addition, the cathode further includes the MPL which can include conductive nanoparticles, such as acetylene black nanoparticles, mixed with a high concentration of PTFE, e.g., from 60 wt % to 99 wt % PTFE, optionally from 80 wt % to 95 wt % PTFE, to create a conductive and hydrophobic surface interface to deposit the cathode catalyst. The dry thickness of the MPL can be between 0.5 μm and 500 μm, optionally between 10 μm and 80 μm. The GDE thus includes a thin PTFE-carbon paper layer and a thin MPL to maximize CO₂ availability at the catalyst and allow any potassium carbonate salts that are formed during the reaction to be dissolved by periodic rinsing with DI water.

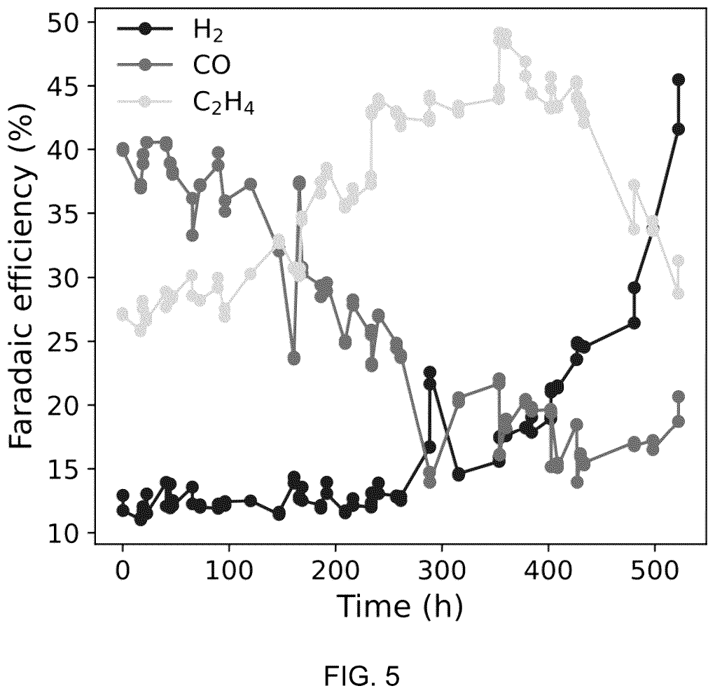

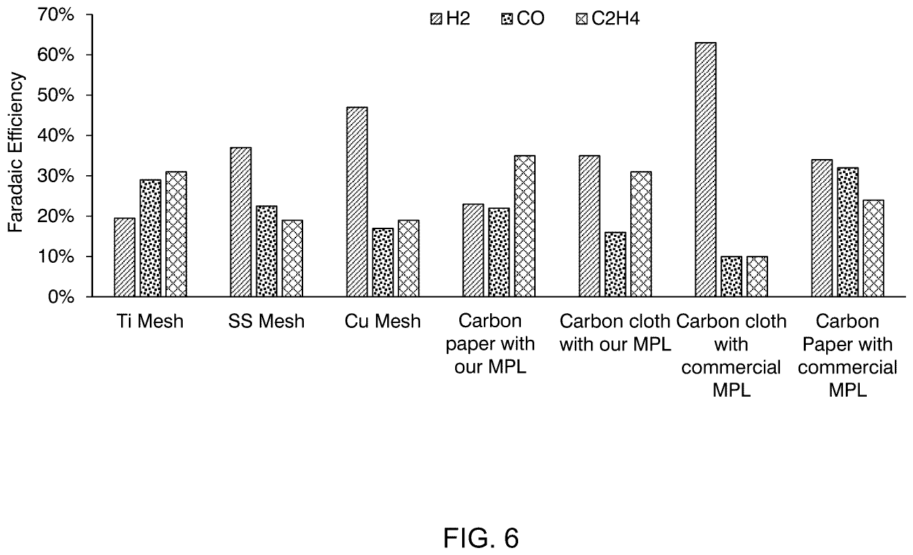

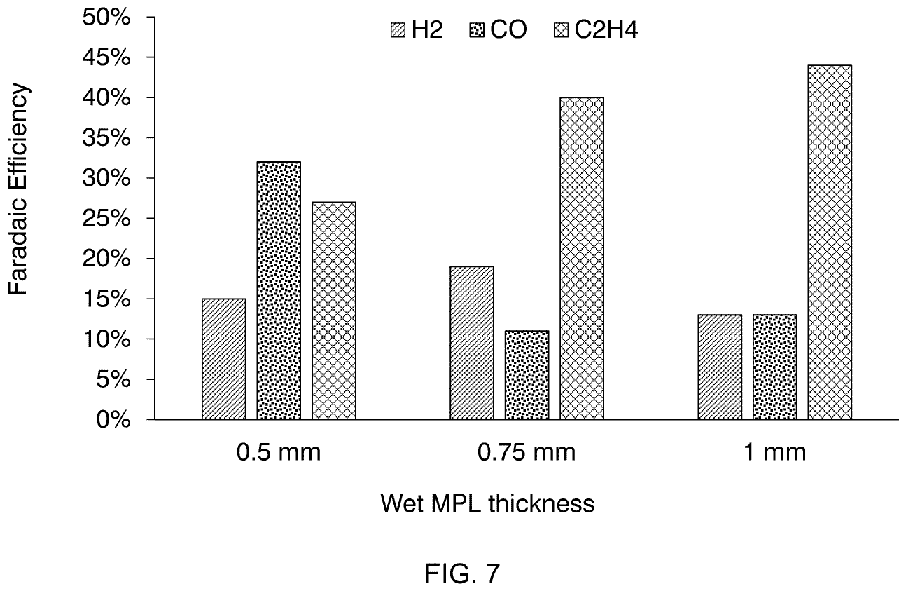

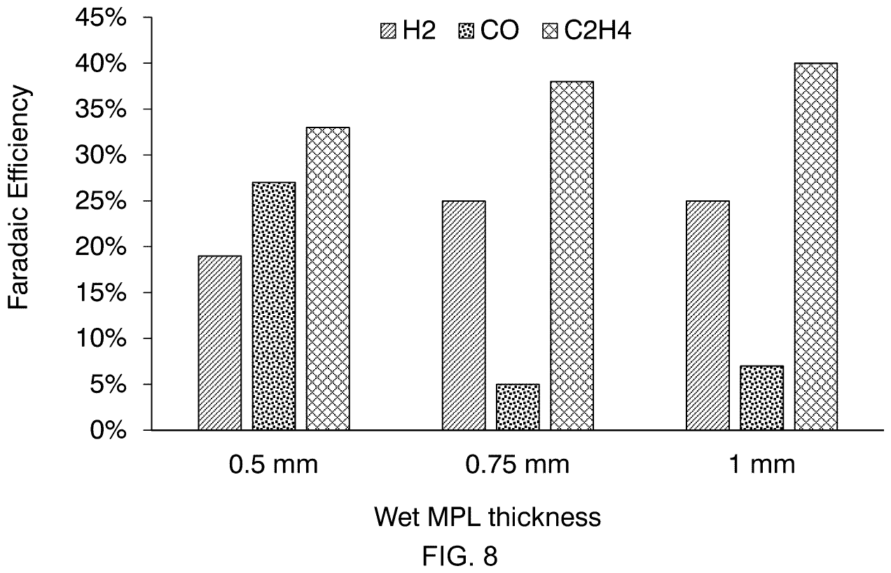

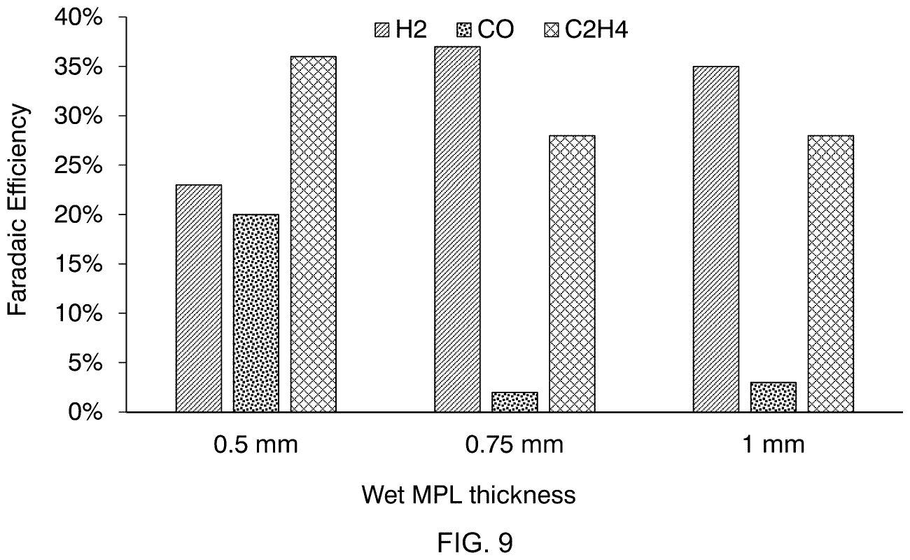

FIGS. 4 to 9 illustrate the performance of a cathode include the GDL as proposed herein according to varying parameters such as the operation duration (FIGS. 4 and 5), the nature of the support layer and the presence of the MPL (FIG. 6), the thickness of the MPL (FIGS. 7 to 9).

The combination of the hydrophobic MPL and the hydrophobic porous support layer including microscale pores can ensure (i) gas transport to reactive sites by preventing flooding of the electrode with liquid products, liquid electrolyte, or condensed water, and (ii) electron transport from the current collector to the cathode. The formed gas diffusion electrode facilitates high current density, selective (either single carbon or multi-carbon gas or liquid products), and stable conversion of CO₂ or CO in a gas phase membrane electrode assembly.

The cathode further includes a catalytic layer. In some implementations, the cathode can further include a stabilization layer. Both layers consist of nanoparticles bonded with a binder (such as an ionomer or PTFE) but their function is different. The nanoparticles of the catalytic layer are chosen to be catalytically active for CO₂/CO electroreduction, and can be sized between 1 nm and 10000 nm, optionally between 10 nm and 100 nm. For example, the catalytic layer can include Cu nanoparticles. The nanoparticles of the stabilization layer are chosen to be stabilizing and electrically conductive, such as titania, ceria, carbon nanoparticles (including carbon nanotubes), graphite, graphene, and silica. The ionomer that can be used to bond the nanoparticles in each one of the catalytic layer and stabilization layer can be Nafion®, Fumion®, or analogs thereof. The ionomer included in the catalytic layer can be the same as or different from the ionomer included in the stabilization layer.

More specifically, the particles of the stabilization layer can have a surface that is modified with a functionalizing group to prevent the catalytic layer from reconstructing during operation of the multiple-layer gas diffusion electrode. The functionalizing group can be an ionized unit, imidazolium, sulfonic acid, poly(aryl piperidinium) of an ion-conducting ionomer, such as the Nafion®, Fumion® referred to above.

Various deposition techniques can be used to deposit the catalytic layer and the stabilization layer. Deposition techniques include drop-casting, blade-coating, gravure-coating, slot-die coating, dry-pressing, electrodeposition, rolling, sputtering, thermal evaporation or any combinations thereof. For example, the catalytic layer and the stabilization layer can be sprayed directly onto the MPL. For example, the catalyst nanoparticles can be mixed with an ionomer, which acts as the binder, as well as increases ionic conductivity to all catalyst nanoparticles and increases CO/CO₂ availability to the catalyst nanoparticles. In some implementations, the porous catalytic layer is formed by dispersing the nanoparticles-ionomer mixture in the surface of the MPL, rather than forming a thin continuous film, to increase the active area and current density for the CO/CO₂ reduction reaction. The thickness of the catalyst layer can be between 100 nm and 10 μm. The stabilization layer can be formed by mixing the nanoparticles with an ionomer, and spraying the mixture onto the catalytic layer. The stabilization layer prevents the catalyst layer from reconstructing (i.e., having the catalyst nanoparticles agglomerating, changing oxidation state, exposed crystal orientation, or particle size due to changes in the potential or pH it is exposed to) during operation and maintain a uniform voltage distribution. The catalytic environment can be further tuned through the selection of the ionomer or other functionalization of the carbon nanoparticles of the stabilization layer.

The cathode including the proposed GDL can be used in a liquid flow cell reactor or a membrane electrode assembly reactor.

The multiple-layer gas diffusion electrode can be manufactured in various ways that are available to one skilled in the art. However, a method was developed to manufacture the presently described and claimed multiple-layer gas diffusion electrode, and is as follows.

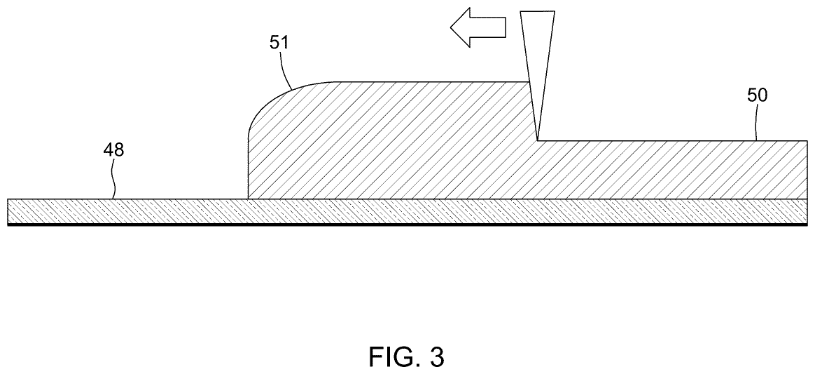

There is further provided a method to produce the cathode, with the method comprising forming the gas diffusion layer, and optionally forming the catalyst layer onto the gas diffusion layer, and further optionally forming the stabilization layer onto the catalyst layer. The forming of the gas diffusion layer includes the forming of the support layer and of the MPL. For example, the forming of the support layer can include dipping carbon paper in a PTFE solution, and then heat treating to melt the PTFE over the carbon fibers of the carbon paper to produce the support layer being a PTFE treated carbon paper. Then, the forming of the MPL includes mixing a carbon nanoparticle ink and a PTFE solution to form an MPL ink, and, as seen in FIG. 3, blade coating the MPL ink 51 on top of the support layer 48, being the PTFE treated carbon paper, to form the MPL 50. Optionally, the blade coating can be performed to form the MPL with a wet thickness between 400 μm and 1000 μm, which will correspond upon drying to a final thickness between thickness between 0.5 μm and 500 μm. Finally, the forming of the gas diffusion layer includes heat treating (sintering) the MPL to melt the PTFE therein. Optionally, the heat treating can include exposing the gas diffusion layer to a temperature between 300° C. and 400° C. in a furnace, such that the PTFE particles sinter together and form with the carbon nanoparticles a cohesive and uniform layer on top of the support layer. The sintering of the PTFE also provides the hydrophobicity of the gas diffusion layer.

In some implementations, the method can further include forming the catalytic layer by spraying a catalyst ink (e.g., mixture of Cu nanoparticles and an ionomer serving as binder in a solvent such as methanol, ethanol and isopropanol) on top of the MPL. The catalytic material in the ink can be a metal, a metal oxide, or a mixed metal. In some implementations, the method can further include forming the stabilization layer by spraying a stabilization ink (e.g., mixture of the carbon nanoparticles and ionomer in a solvent such as methanol, ethanol and isopropanol) on top of the catalyst layer.

As seen in FIG. 5, the formed multiple-layer GDE can be used as a cathode for sustaining electrochemical reduction of gaseous CO₂, CO, or a combination thereof into carbon products. When used as a cathode, the multiple-layer gas diffusion electrode demonstrated exceptional stability. For example, when coupled with a salt mitigation (periodic rinsing) and copper mesh strategies as described herein, the stability was further improved and reached several hundred hours (e.g., at least 500 hours) of operation while maintaining selectivity for ethylene product of at least 25%. The unique electrode configuration facilitated all critical transport functions (reactants, electrons, ions, products).

Hydrophilic spacer for electrochemical conversion of CO₂

Ion exchange membranes are key components of membrane electrode assemblies for CO₂, CO, or other electrolyzers. They separate the anodic and cathodic compartments and complete the ionic circuit between the two by allowing ions to selectively pass through. Membrane stability is critical to the MEA electrolyzer stability. Membranes can fail due to mechanical instabilities caused by mechanical punctures, dry out, chemical degradation, etc. The current state-of-the-art solutions in the field are to use reinforced membranes; however, these reinforced membranes offer increased cell voltages, poorer membrane-electrode contact, and degrade over time.

Mechanical stability problems can be overcome with the presently proposed MEA design, while maintaining good membrane-electrode contact and no degradation with time. To avoid membrane holes and short circuits, there is provided a hydrophilic spacer that can be used as at least one layer that separates the ion exchange membrane from the anode within the MEA. For example, referring to FIG. 1, the hydrophilic spacer 38 can be provided between and in contact with the anode 34 and the anionic exchange membrane 36 (AEM).

Referring to FIG. 1, the hydrophilic spacer can consist of a non-conductive porous hydrophilic layer, having a thickness between 0.001 mm and 3 mm, a porosity between 10% and 90% with a pore size between 0.0001 mm and 1 mm. The non-conductive porous hydrophilic layer is placed between the anode and the ion exchange membrane of the MEA to serve as the hydrophilic spacer, by being adhered to, fastened to, hot-pressed (electrode), placed against, or pressed against the anode and/or ion exchange membrane of the MEA. The anolyte flows along the spacer and wets its surface. The spacer stabilizes the ion exchange membrane in the MEA system, providing mechanical support to the membrane, providing continuous membrane hydration and ionic connection, and preventing an electrical short in the event of membrane failure.

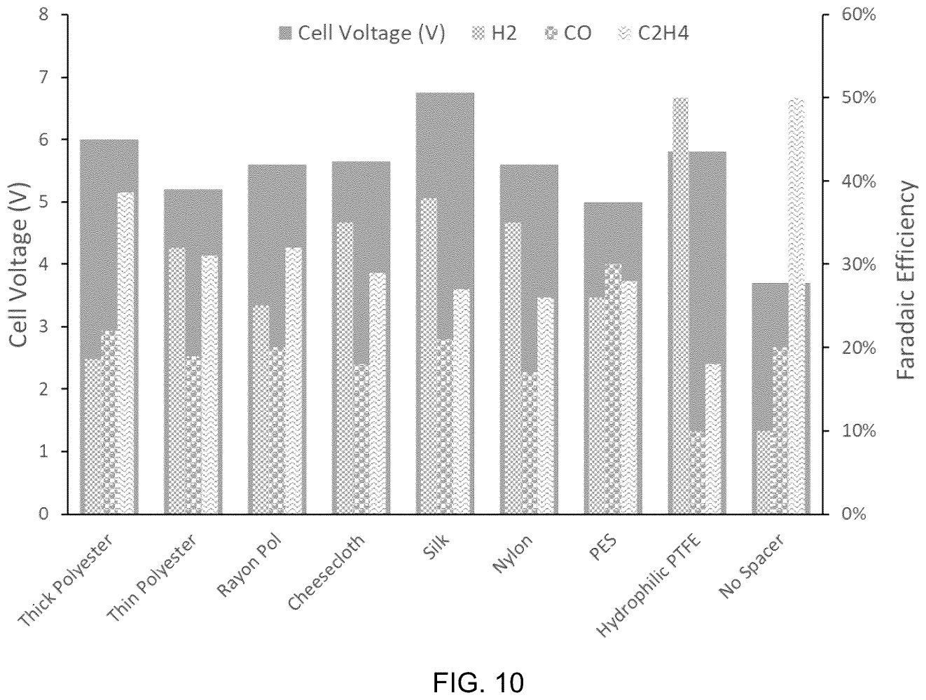

Referring to FIG. 10, a variety of materials can be used as layers for the hydrophilic spacer, but the choice of material has an impact on the selectivity and voltage of the electroreduction reaction. The material can also be selected based on its compatibility with the pH of the reaction and with the electrolytes. In some implementations, the non-conductive porous hydrophilic material can be polyester, rayon, silk, cotton, cheesecloth, PES, nylon, hydrophilic PTFE, cellulose, polypropylene, polyethylene, or any combinations thereof.

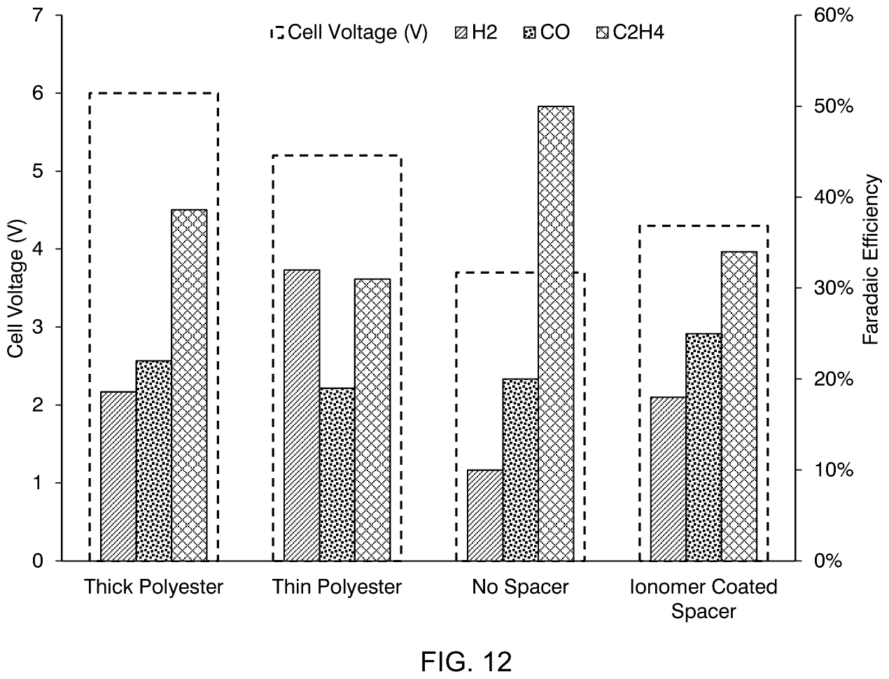

In some implementations, the hydrophilic, porous and non-conductive layer of the spacer can be functionalized with an ionomer or another chemical to increase the ionic conductivity and chemical reaction selectivity of the MEA. More particularly, the spacer can include a coating of an ionomer. Referring to FIG. 12, an ionomer coating has been shown to reduce the cell voltage and increase C₂H₄ selectivity with respect to hydrophilic spacers that do not include said coating.

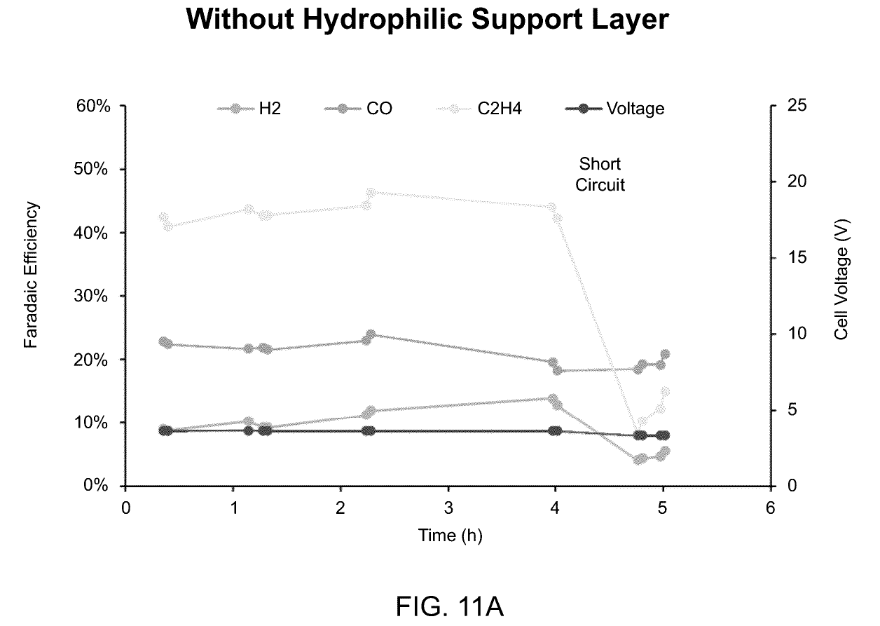

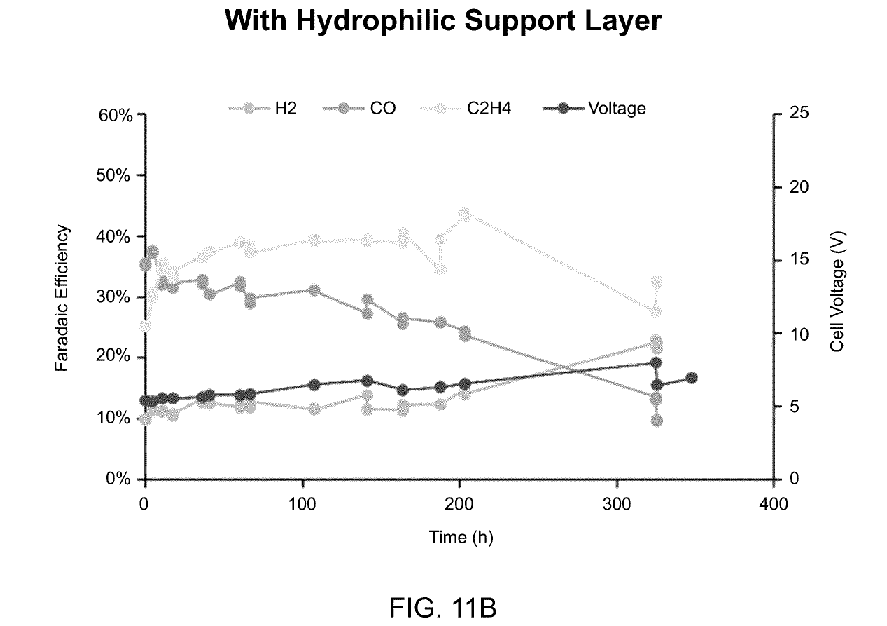

Referring to FIGS. 10, 11A and 11B, one can see that the presence of the hydrophilic spacer has a lowering impact on the Faradaic efficiency (FE) for ethylene and an increasing impact on the cell voltage, and that for all materials that were tested in FIG. 10, even though the hydrophilic spacer is on the anode side of the MEA. However, referring to FIGS. 11A and 11B comparing longevity of the performance of the MEA including or not a hydrophilic spacer, one can see that the MEA including the hydrophilic spacer can perform at a selectivity for ethylene of at least 20%, 25% or 30% for an extended duration in comparison with the MEA that does not include the hydrophilic spacer.

The non-conductive hydrophilic spacer stabilizes the ion exchange membrane in the membrane electrode assembly, providing mechanical support to the ion exchange membrane, keeping the membrane hydrated and ionically connected, and preventing an electrical short in the event of membrane failure. Longevity of MEAs including a hydrophilic spacer can be further explained by the fact that the hydrophilic spacer is puncture-resistant, and by separating the sharp anode fibers from the ion exchange membrane, can thus minimize punctures, and extend the lifetime of the MEA.

### Support Structure for Enhanced CO₂ Delivery, Support, Thermal Management

Membrane electrode assemblies (MEAs) can be employed to electrochemically convert carbon dioxide (CO₂) or carbon monoxide (CO). As reactors employing this technology grow in size (>5 cm²), they employ channels (e.g., in serpentine configuration) to better control reactant and product flows along the surface of the MEA. In this approach, unsupported channel regions suffer from reduced electrical contact with the flow field/current collector and mechanical instability in the MEA. In addition, the cathode/anode area directly above the land areas of the flow field experience decreased mass transport since species must diffuse a far distance from the channel to reach these areas and vice versa. This reduced mass transport results in limited access to CO₂/CO reactant gas which harms the reaction efficiency. Moreover, due to the heat emitted from the reaction, these areas are likely to reach higher temperatures which can damage the MEA and/or electrolyzer components.

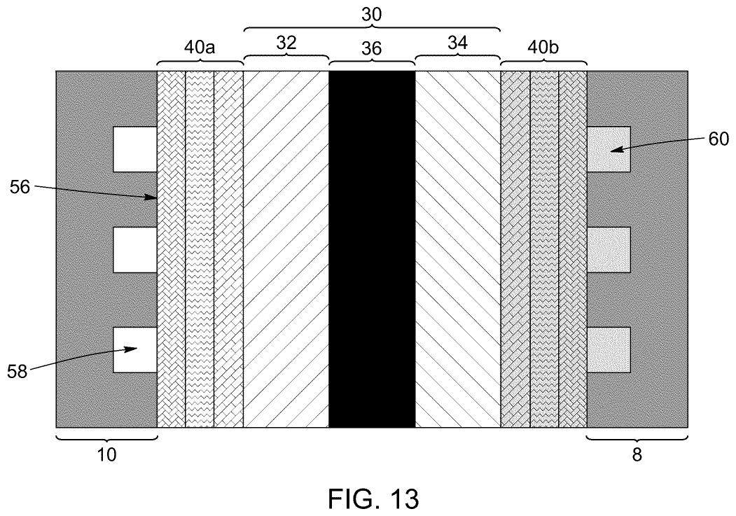

The proposed electroreduction reactor can include a conductive porous support structure that is used in combination with a MEA, such as the MEA described herein, a cathodic flow field and an anodic flow field. The support structure can include a pair of opposed support substructures, each support substructure being provided at one side of the membrane electrode assembly to uniformly maintain the membrane electrode assembly in between the pair of opposed support substructures. For example, each support substructure can be placed on either side of the cathode and/or anode of MEA, between the flow fields and the MEA. This support structure provides mechanical support and compression to the MEA and distributes the electrical current evenly across the cathode and/or anode from the current collector/flow field of the electroreduction reactor. When used in combination with the present support structure, the flow fields can be designed with larger channels (than in absence of the support structure), facilitating rinsing with water to avoid salt and other obstructions, while avoiding increasing a pressure drop in the flow field channels. The support structure thus enhances mixing in reactor dead spots along and between flow field channels, thereby facilitating delivery of the CO₂/CO to the catalyst of the cathode, transport of reaction products away from the cathode, and heat transfer to remove excess heat generated from the reaction. Each support substructure can include at least one layer of a porous and electrically conductive material. The porous and electrically conductive material can be a metallic mesh that supports the MEA to perform several key functions. For example, at least one mesh support layer can be added to both the cathode and anode sides of the MEA to facilitate the flow of reactants to the catalyst and compression. As seen on FIG. 1, the thickness of the support substructure on the cathode side can vary from the thickness of the support substructure on the anode side. Referring to the implementation shown in FIG. 13, each support substructure can for example comprise three layers of metallic mesh.

The presence of the support structure is particularly beneficial to systems having a large cell area (e.g., at least 100 cm², or at least 800 cm²) because, as seen on FIG. 13 showing a portion of a large cell area, the support structure (40 a, 40b), being layered metallic mesh, supports the membrane electrode assembly 30 including the cathode 32, ion exchange membrane 36, and anode 34, due to an increased number of channel areas 58 and 60 in comparison to existing smaller cell areas.

The porosity of at least one layer of each support substructure can be at least 50%, and the pore size can be between 0.1 mm and 10 mm. The shape of the pores of the support substructure can vary and include a diamond shape, a circular shape, a square shape, a triangular shape, a hexagonal shape, and an ellipse shape. The at least one layer can be a perforated mesh, an expanded mesh, a flat mesh, a multilayered mesh, a welded wire mesh, and a woven wire mesh. Each layer can have a thickness varying between 100 μm and 5 mm. The material of each layer is an electrically conductive material that can be a metal or alloy. The material can include titanium, copper, aluminum, stainless steel, bronze, brass, galvanized steel, platinum, nickel alloys, carbon, carbon steel, iron, lead, or other electroplated/electroless plated metallic mesh. Electrical conductivity and fluid flow dynamics of the support substructure can be tuned by selecting its pore size, pore shape, pore distribution, strand orientation of each layer, and the number of layers of the substructure. Optionally, turbulence enhancers can be added onto the at least one layer as part of the support substructure, being for example ribbed or spiral-shaped components to disrupt the flow.

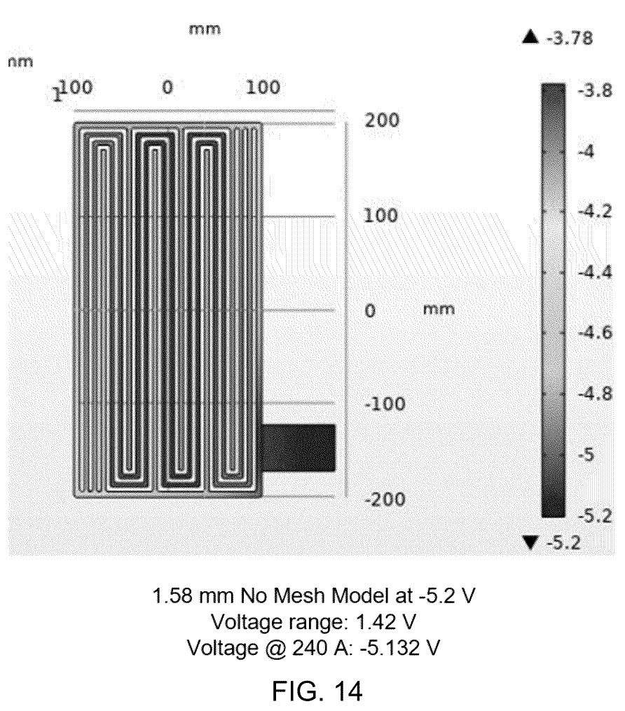

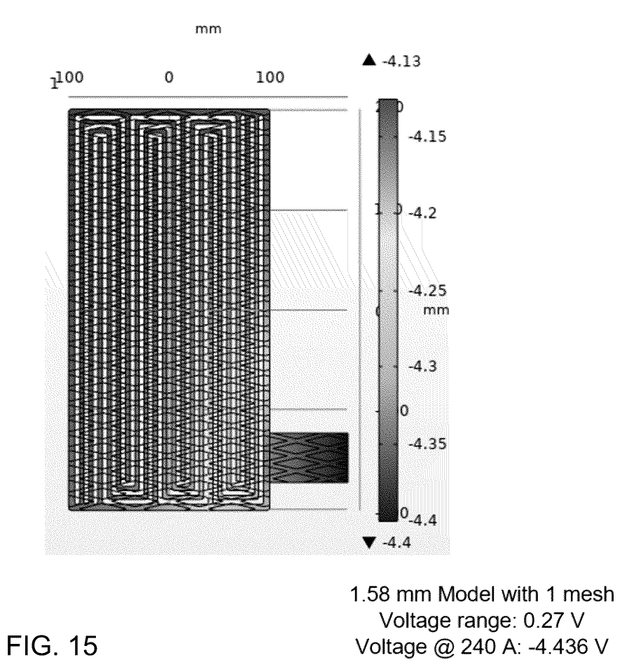

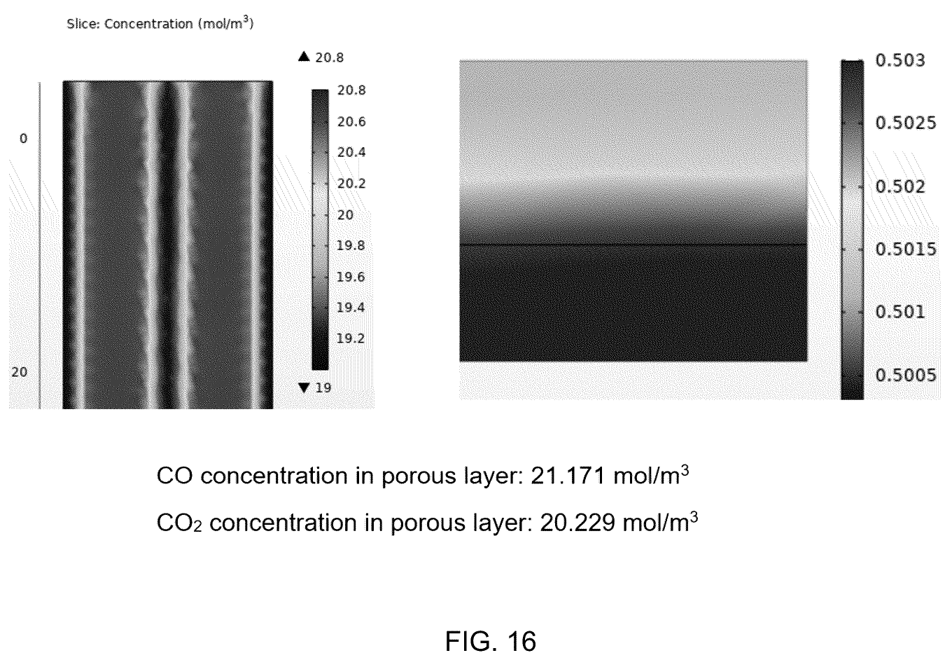

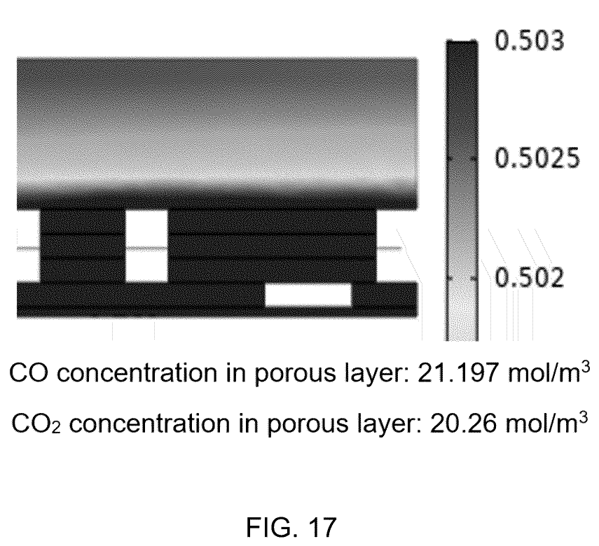

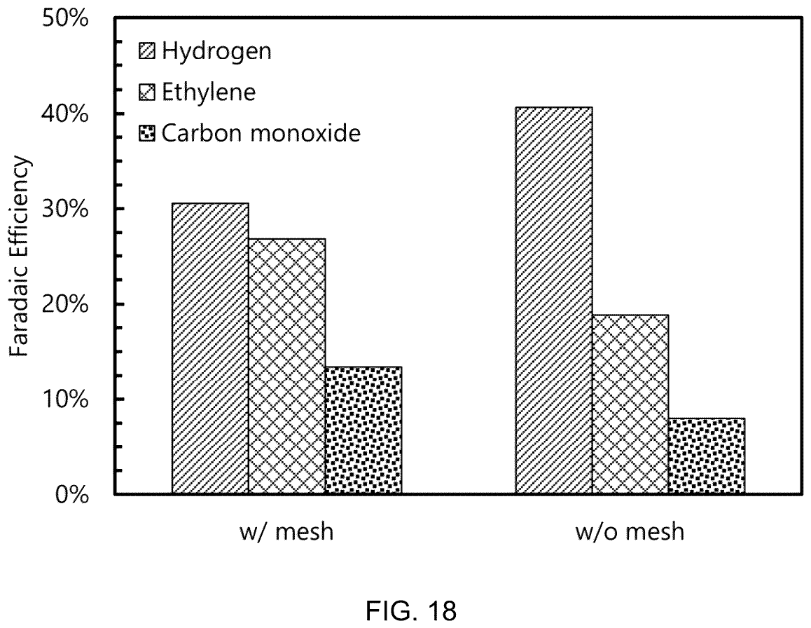

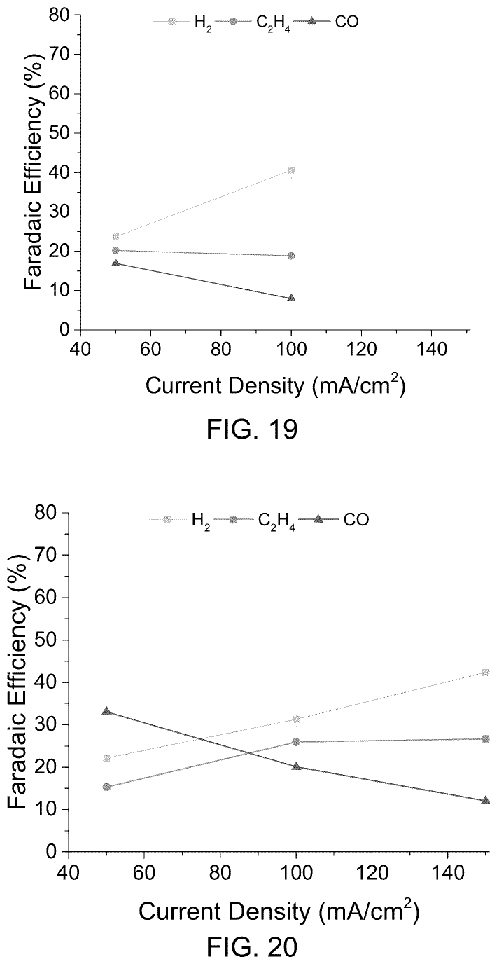

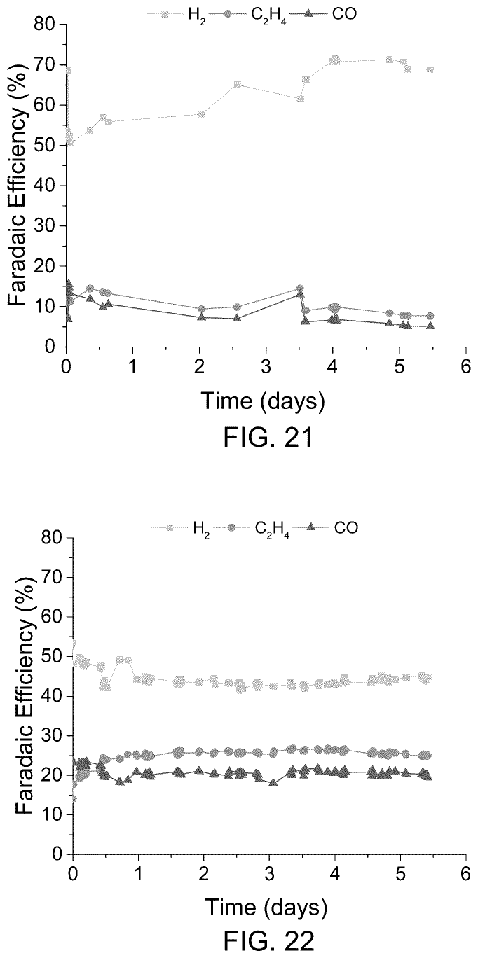

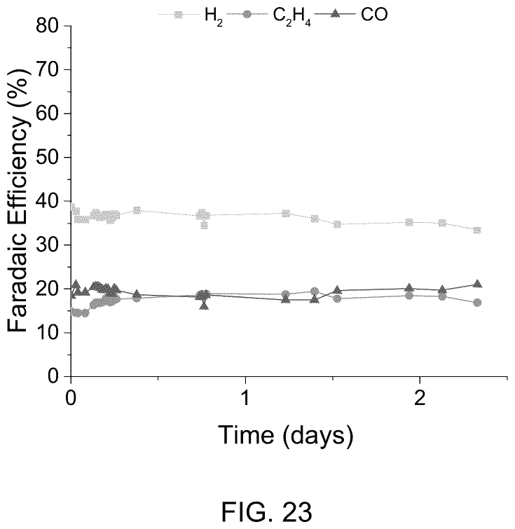

COMSOL modelling can be used to aid in the selection of the mesh size and configuration. More particularly, the computer simulation can be used to predict the concentrations of CO₂ and CO during electroreduction, with an electrolyzer reactor being supplied with 50 mol. % CO₂ and 50 mol. % CO at atmospheric conditions. For example, a titanium or copper mesh can be selected for the cathode side to facilitate uniform compression to the MEA over the flow field channel area, and provide CO₂ access to the entire catalyst surface of the cathode. One to four layer(s) of titanium or copper mesh with large pores (2-3 mm) can be selected for the cathode side because it is a poor H₂ catalyst, and the pores are large enough not to be filled with water during operation. Comparing FIGS. 14 and 15, the mesh substructure of the cathode side provided a uniform electrical connection between the cathode and the cathode flow field (e.g., with a voltage difference of at most 160 mV at 240 A across the active area), and the mesh is shown to reduce the voltage needed to operate the electrolyzer reactor. Comparing FIGS. 16 and 17, the mesh support substructure of the cathode is shown to improve reactant CO₂ and product CO mass transport to and from the catalyst sites, respectively. Referring to FIG. 18, the improvement in mass transport results in a further improvement of the FE toward ethylene production (about 27% FE with a cathode mesh in comparison to about 19% FE without the cathode mesh), for example. Comparing FIGS. 19 and 20, the electrolytic cell including a cathode with no mesh support substructure reaches mass transport limitations at 100 mA·cm² (with high FE in H₂ and low FE in products), whereas the cell including the cathode with the one-layer Ti mesh still has good product selectivity at 100 mA·cm². Comparing FIGS. 21 and 22, the support substructure configuration (number of layers and pore size) is shown to alter the fluid dynamics and mass transport of CO/CO₂, which affects both the selectivity and stability of the reaction. FIG. 23 is an example of the substructure being a copper mesh, and showing that different metals can be used to form the substructure.

On the anode side, at least one mesh layer can also be added to aid the transport of anolyte to the anode catalyst, thus providing uniform cooling to the cell. The oxidizing cell potential on the anode side can favour the use of titanium, for example, as the mesh material due to its corrosion resistance. The mesh support substructure on the anode side can be typically comprised of 2-5 layers of a fine mesh, and tuned to the depth of each cell.

There is provided herein an electrolyzer reactor including the support structure as defined herein, that includes the cathodic support substructure being sandwiched between the cathode flow field and the cathode, and the anodic support substructure being sandwiched between the anode flow field and the anode. Each support substructure includes at least one layer of metallic mesh that can be welded, adhered, fastened, hot-pressed to the flow field and/or the electrode. Alternatively, at least one layer of metallic mesh can be simply physically placed or pressed against the flow field and the electrode. Each support substructure is configured to adequately contact the conductive flow field and the electrode to provide an electrical path with minimum resistance between the flow field and the electrode.

Although implementations of the support structure are described above as including two support substructures, it should be noted that the support structure can include a single support substructure that is placed on one side only of a MEA in a CO₂ electrolyzer (e.g., cathode side or anode side).

Electrolyzer Stack Reactor for the electrochemical conversion of CO₂, CO, and other chemical feedstocks

Commercially available CO₂ electrolyzer reactors are typically limited to small areas (<5 cm²) and single cell design. Such reactors can be useful for testing catalysts and reaction conditions at the lab scale, but if industrially scaled conversion rates are to be realized, both the cell size and number of cells need to be increased. Once cells are combined, any defects in a single cell will have impacts on the overall performance. Known CO₂ and water electrolyzers can use a bipolar stack arrangement wherein the cells are electrically connected in series. In the event that a single electrochemical cell is defective, the entire stack will not function correctly. For example, if one cell has a very large resistance then it will occupy most of the voltage provided to the stack, leaving much less for the other cells. This large resistance can develop during assembly or after some time of operation. In a purely bipolar arrangement, isolating the defective cell requires disassembling the stack.

There is provided herein a monopolar CO₂ electrolyzer stack reactor that is designed and operated to diagnose a faulty electrochemical cell and isolate such cell electronically and/or hydrodynamically, to achieve efficient performance in the overall stack.

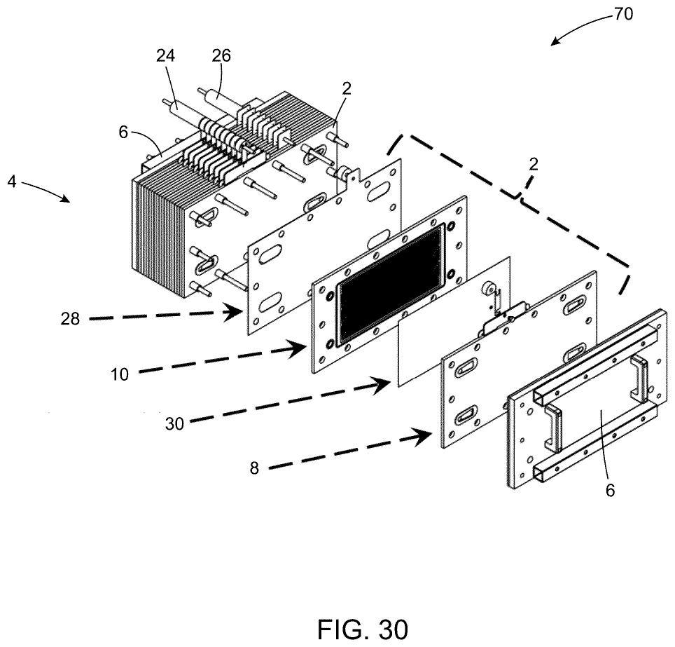

Referring of FIG. 30, the electrolyzer stack reactor 4 includes two end plates 6, and multiple repeat cell units 2, with the end plates 6 being secured together with a threaded assembly. The electroreduction reactor that is described herein can be used as a repeat cell unit 2 that is stacked to form the electrolyzer stack reactor 4 including multiple repeat cell units 2, thereby being designed to perform the electrochemical CO₂ reduction reaction in a modular and scalable way. For example, the electrolyzer stack reactor can include between 2 and 100 electrochemical repeat cell units that are stacked. The cell area (active surface) of each repeat unit can be tuned between 5 cm² and 2 m², optionally between 100 cm² and 10000 cm²

Still referring to FIG. 30, each repeat cell unit 2 can comprise two flow field assemblies (e.g., anodic flow field assembly 8 and cathodic flow field assembly 10, either metallic or plastic based); a membrane electrode assembly 30 (e.g., as detailed in FIG. 1); and optionally a support structure 40 as described herein including a cathodic substructure 40a and an anodic substructure 40b on sides of the membrane electrode assembly (e.g., as detailed in FIG. 1, not apparent in FIG. 30). The flow field assemblies (8, 10) distribute the gas phase and liquid phase reactants to the cathode and anode, respectively, in the membrane electrode assembly of each repeat cell unit 2.

The repeat cell units are thus connected in parallel, such that a large current is applied to the ends of the electrolyzer stack reactor, and each repeat cell unit receives a portion of the current and a similar voltage. The current going towards each repeat cell unit can be measured, and the electrical connection to the repeat cell unit broken if the repeat cell unit is damaged. Breaking the electrical connection to the repeat cell unit reduces the amount of active area but enables the rest of the stacked repeat cell units to continue operating. In some implementations, the cathode and anode fluid flow to each repeat cell unit can be individually modulated via manifold assembly. Consequently, in the event that a membrane rupture has taken place in a repeat cell unit, the cathode and/or anode fluid flow to that defective repeat cell unit can be stopped and the repeat cell unit can be electrically disconnected.

More particularly, if a repeat cell unit in the stack is shorted, then the measured cell voltage will be lower for this repeat cell unit than in regular operation to achieve the same current. For example, to achieve currents of at least about 80 A, the cell voltage can be at least about 3.0 V during regular operation, and a shortage can be detected upon measuring a cell voltage of less than about 2 V, typically less than about 1 V. For example, the current flowing into each repeat cell unit can be measured at tabs using a handheld clamp meter.

The electrolyzer stack reactor thus further includes the manifold assembly in fluid communication with the flow fields of each repeat cell unit to distribute the reactant fluids (i.e., CO₂, CO or the mixture thereof, and electrolyte) to the anode and cathode of each membrane electrode assembly. For example, the manifold assembly can include two separate inlet manifolds to feed the reactant fluids to the multiple cathodes and anodes respectively, i.e., an anode inlet manifold and a cathode inlet manifold. The manifold assembly can further include two separate outlet manifolds to recover the product fluids and used electrolyte from the multiple cathodes and anodes, i.e., an anode outlet manifold and a cathode outlet manifold. Each manifold can be internal or external to the repeat cell units. In addition, the anode manifolds can be different from the cathode manifolds. For example, cathode inlets and outlets can be manifolded internally, whereas anode inlets and outlets can be manifolded externally.

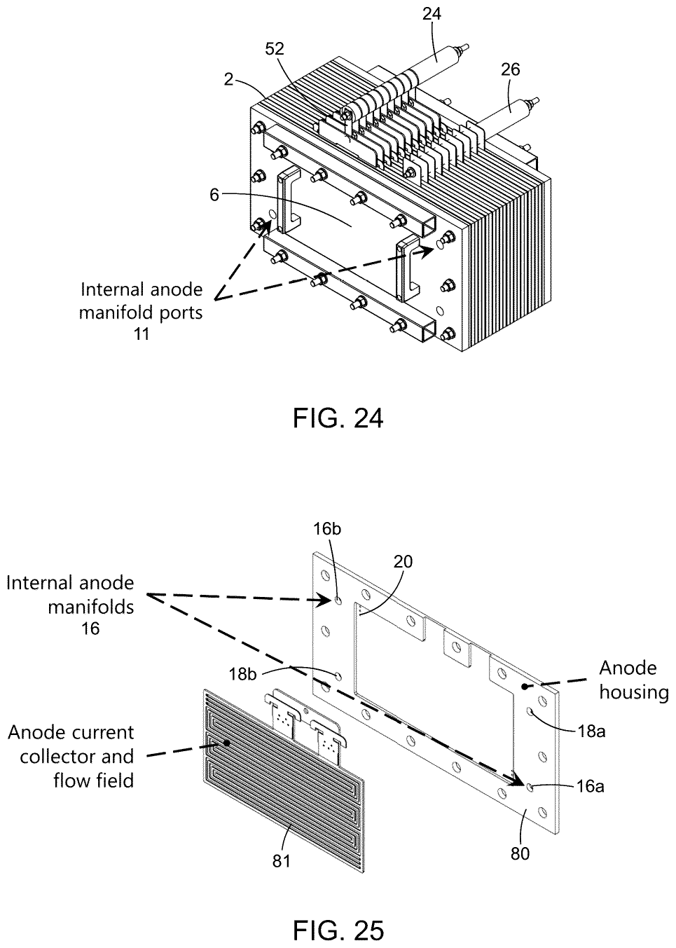

In the implementation illustrated in FIGS. 25, 27 and 28, the manifolds are internal, which means that the fluids only flow through distribution channels that are internal to each repeat cell unit. Referring to FIG. 24, each one of the internal inlet manifolds and internal outlet manifolds comprises an inlet end port or an outlet end port defined by a hole 14 in each of the end plates 6, each hole 14 being in fluid communication with the channel of the corresponding manifold. For example, as exemplified in FIG. 29, the reactant fluids can be fed to the cathode inlet manifold via the inlet end port 14a defined in each of the two end plates 6; and the cathode outlet manifold can release the product fluids via the outlet end port 14b defined in each of the two end plates.

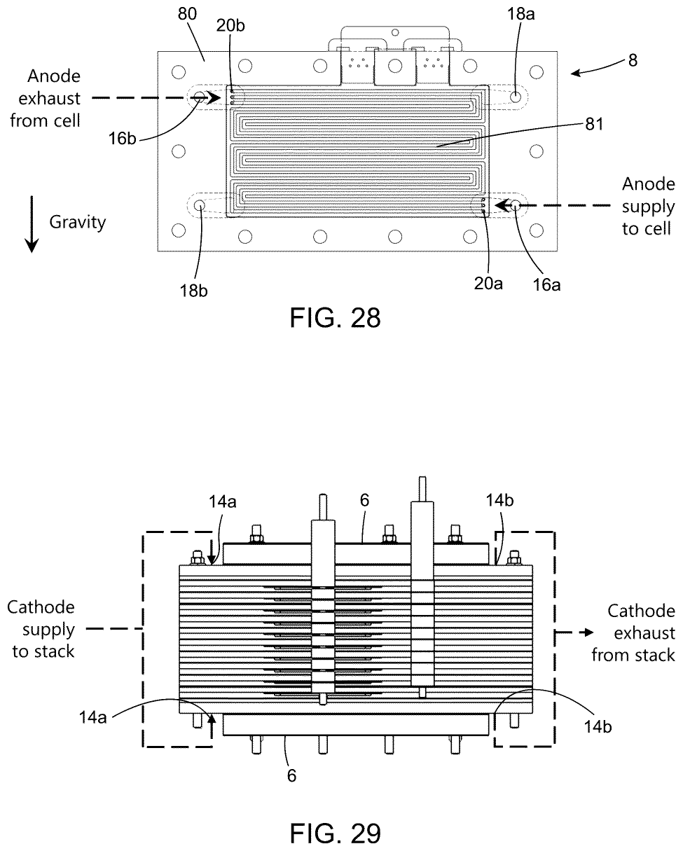

The distribution channels of the internal manifolds are further defined via additional ports provided in the cathodic flow field and the anodic flow field of each one of the stacked repeat cell units. Referring to FIG. 25, an anodic flow field (and current collector) assembly 8 can include a housing 80 and an anodic flow field (and current collector) insert 81 that is configured to be encased in the housing 80. In the implementation illustrated in FIGS. 25 and 28, the anode inlet manifold comprises a series of inlet ports 16a defined in the housing 80 of each anodic flow field assembly 8 of the repeat cell units, and the anode outlet manifold comprises a series of outlet ports 16b defined in the housing 80 of each anodic flow field assembly 8 of the repeat cell units. The anode inlet and outlet manifolds further include secondary ports 20 that are in fluid communication with the flow channels of the anodic flow field insert 81. As better seen in FIG. 28, the secondary ports 20 comprise inlet secondary ports 20a that conduct the electrolyte from the inlet port 16a of the anode inlet manifold into the flow channels of the anodic flow field insert 81, and outlet secondary ports 20b that conduct the used electrolyte from the flow channels of the anodic flow field insert 81 into the anode outlet manifold via outlet port 16b. The same principle is followed for the cathode inlet and outlet manifolds. Referring to FIG. 27, the cathode inlet manifold comprises a series of inlet ports 18a defined in a housing 100 of each cathodic flow field assembly 10 of the repeat cell units 2, and the cathode outlet manifold comprises a series of outlet ports 18b defined in the housing 100 of each cathodic flow field assembly 10 of the repeat cell units 2. The cathode inlet and outlet manifolds further include secondary ports 22 that are in fluid communication with the flow channels of the cathodic flow field insert 101. Still referring to FIG. 27, the secondary ports 22 comprise inlet secondary ports 22a that conduct the reactant fluids from the inlet port 18a of the cathode inlet manifold into the flow channels of the cathodic flow field insert 101, and outlet secondary ports 22b that conduct the product fluids from the flow channels of the cathodic flow field insert 101 into the cathode outlet manifold via outlet port 18b.

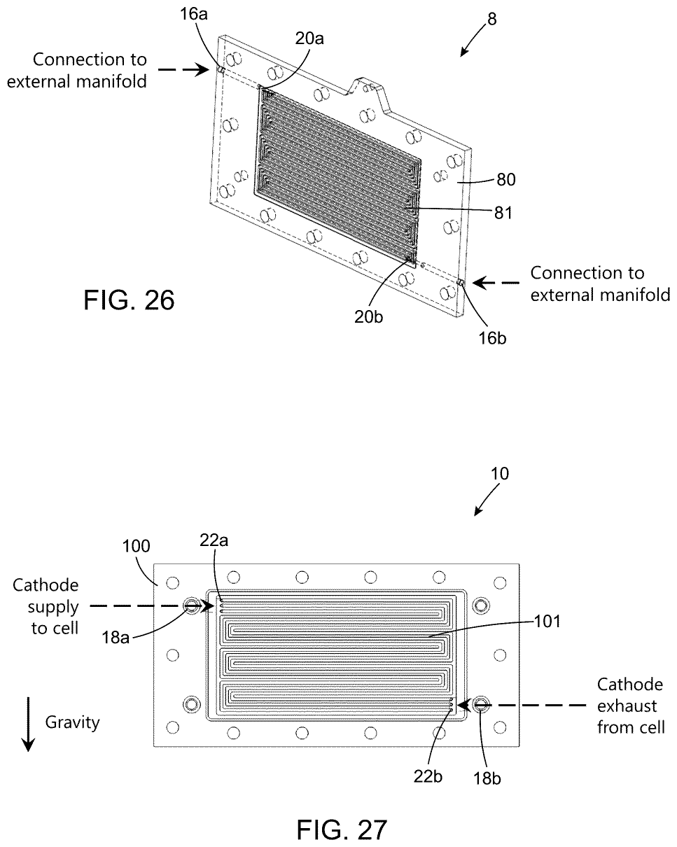

In the implementation illustrated in FIG. 26, the manifolds are external, which means that the fluids only flow through distribution channels that can be external to each repeat cell unit, and can be defined by a separate tube or header. FIG. 26 illustrates the inlet port 16a and outlet port 16b that are in fluid communication with an external distribution channel (not illustrated) of the anode inlet and outlet manifolds. The inlet port 16a and outlet port 16b respectively fluidly connected to secondary inlet port 20a and secondary outlet port 20b to feed and expel fluids to and from the flow channels of the anodic flow field insert 81.

The manifold assembly of the electrolyzer reactor stack ensures to feed reactants and to recover products to and from the anodic and cathodic flow fields in parallel. It should be further understood that the distribution channels (external or internal) of the manifold assembly are configured to let the cathode fluids flow through the anode plates of the repeat cell units, and let the anode fluids flow through the cathode plates of the repeat cell units. The manifold assembly can be tuned for each individual repeat cell unit. The direction of the reactant flow via the anode inlet manifold and cathode inlet manifold as illustrated in the Figures is provided as an example, and such direction of the reactants can be altered to co-flow or counterflow with each other via the anode inlet manifold and cathode inlet manifold.

It should be noted that the orientation of the manifold can impact the overall reactor performance. The reactant feed can enter the top of each repeat cell unit via the cathode inlet manifold and exit near the bottom of each repeat cell unit via the cathode outlet manifold so that any liquid products and condensate can be easily cleared using gravity. The electrolyte feed can enter the bottom of each repeat cell unit via the anode inlet manifold and exit near the top of each repeat cell unit via the anode outlet manifold so that any bubbles will flow up and out without blocking flow and distribution channels. The inlet manifolds can feed into the cells from the front or back of the stack in one location (unidirectional), or from both the front and back of the stack (bidirectional, as seen in FIG. 29). It was observed that the bidirectional feeding of CO₂ into the electrolyzer reactor stack can improve the uniformity of the CO₂ distribution amongst the repeat cell units, especially as the electrolyzer reactor stack grows in repeat cell unit number.

Regarding electrical connection, referring to the stack reactor 70 of FIG. 30, the current is applied to each repeat cell unit 2 in parallel through common bus bars 24 and 26 that are connected to the current collector of the anodic flow field (and current collector) assembly 8 and the cathodic current collector 28. This parallel connection allows for a low voltage, high current operation. Operation can include monitoring a stack voltage to detect a short circuit, and further monitoring current at each repeat cell unit tab to particularly detect the faulty repeat cell unit. Referring to FIG. 24, the parallel arrangement allows disconnection of cell fuses 52 to isolate the repeat cell units 2 that have failed from the rest of the stack. For example, the fuses 52 can be provided on the anode side, in series with the anodic busbar 24.

Depending on the type of manifold that is chosen for the electrolyzer stack reactor, the materials of the anodic flow field assembly can be tuned to avoid shunt currents. If internal manifolding is used, then fluid must travel through plastic pieces to avoid such shunting. For example, the anodic flow field assembly can include a plastic housing when used in combination with an internally manifolded electrolyte that is thus not exposed to the cells. Referring to FIG. 25, the anode housing 80 of the anodic flow field (and current collector) assembly 8 can be made of plastic with internal anode inlet and outlet manifolds, whereas the current collector/flow field insert 81 can be made of metal. In another example, referring to FIG. 26, the anodic flow field (and current collector) assembly 8 can be fully designed with metal and used in combination with the electrolyte being externally manifolded. These two designs overcome the issue of shunt currents, wherein the current applied to the cell will travel through the conductive electrolyte rather participating in the electrochemical reactions and potentially short circuit the reactors.

### Cathode Rinsing Method and System for Electrolyzers

Cations that migrate through the ion exchange membrane during CO₂ electroreduction can form solid salts with the bicarbonate or carbonate anions on the cathode side of a CO₂ electrochemical reactor. Once the gas diffusion layer of the cathode, the flow field, or the mesh support substructure gets filled with solid salt, the CO₂ is not able to reach the catalyst, the reduction reaction of CO₂ stops, and no new CO₂ reduction product is produced. Disassembling, clearing the salt, and reassembling large reactors can take 1 to 2 hours and may be required several times per day, so the reactor is not able to be operational continuously. Typical metals used as CO₂ reduction catalysts can be irreversibly changed by the momentary positive potentials seen from discharging the electrolyzer reactor when turning off the electrolyzer reactor to clean the salt formation. The objective for this invention is to clear out these blockages such that the reactor can continue to operate at its maximum capacity.

There is provided a system for rinsing any salt formation or other obstructions in the gas diffusion electrode (cathode), the support structure (mesh), and/or the flow fields of an electrolyzer reactor as described herein. At least the rinsing operation can be performed manually or automatically.

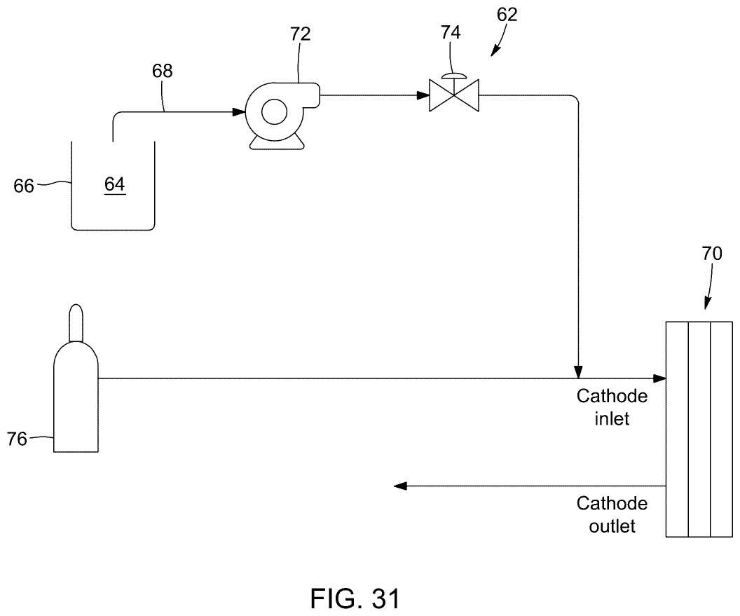

Referring to FIG. 31, the electroreduction system comprises a water distribution assembly 62 that is configured to periodically provide a rinsing fluid 64, e.g. water, to the cathodic compartment of the reactor 70 (being for example the CO₂ electrolyzer in FIG. 30 including cathodic flow field assembly (housing+insert) 10) once electroreduction has operated for a certain electroreduction period. The distribution assembly 62 can include a rinse water reservoir 66 and tubing 68, the tubing being in fluid communication with the cathodic compartment of reactor 70 to provide rinse water 64 from the reservoir 66 to the cathodic compartment of the electrolyzer reactor 70. The distribution assembly 62 further includes a pump 72, and a valve 74 that are mounted on the tubing 68 to open the flow within the tubing and control the flow rate of the rinse water 64 in the tubing 68 to the cathodic compartment.

For example, the system can be automated to rinse with water periodically using automated valves and pumps or manually with hand valves and pumps. The present system avoids having to disassemble and reassemble the electrolyzer reactor each time there is an obstruction, and acts as preventative maintenance to alleviate the creation of obstructions before such obstructions fully block available channels in the cathodic compartment.

The operation of the rinsing system, referred to as the rinsing operation, can thus increase the electrolyzer reactor stability by clearing any obstructions in the cathodic compartment (cathode, mesh support substructure, and/or flow field) with the rinsing fluid and increases the hydration of the ion exchange membrane of the electrolyzer reactor. For example, the electrolyzer reactor can be operated with a stable performance for at least 100 hours.

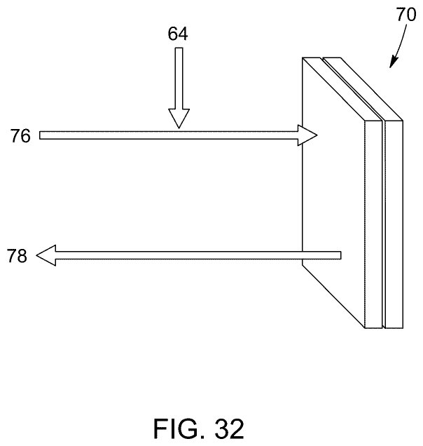

Referring to FIG. 32, the rinsing operation includes co-feeding the rinsing fluid 64 and CO, CO₂ or a mixture thereof 76 to the cathodic compartment of the electrolyzer reactor 70. Thus, the rinsing system rinses the cathodic compartment while the electroreduction reaction is still live. This means that there is no disassembling of the reactor required, which minimizes loss of productivity time. During rinsing, the rinsing fluid is pushed into cathode inlet along with the gaseous reactants and further out of the cathode outlet as a salt-enriched water along with electroreduction products and remaining CO₂ (as gas-liquid mixture 78). With periodic rinsing of the cathode, salt could be effectively removed, and stable operation could be maintained for several hundred hours. The system can thus further include a collection tank or waste container to store and/or recirculate the salt-enriched water.

In some implementations, referring to FIG. 31, the rinsing operation can particularly include opening the valve, and further actuating the pump to move water from the reservoir to the cathode inlet of the electrolyzer reactor to be carried throughout the cathode flow field along with CO₂, CO or the mixture thereof. After a certain period of time, referred to as the rinsing period, the pump can be turned off and the valve can be closed. For example, the rinsing period can have a duration between 20 seconds and 30 minutes, and optionally between 1 and 3 minutes.

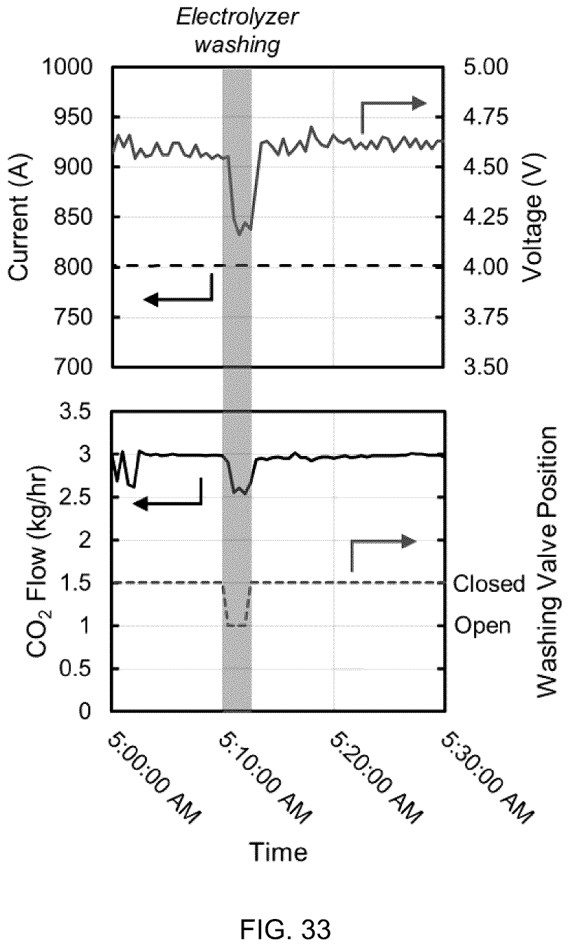

It should be noted that during the rinsing period, the CO/CO₂ flow rate that is co-feed with the rinsing water can be reduced and is selected in accordance with the water flow rate. For example, a ratio of the volumetric flow rate of rinsing water to that of the CO₂, CO or the mixture thereof (CO/CO₂ flow rate) can be chosen between 0.001 and infinite (CO/CO₂ flow rate), with a further typical range of 0.05 and 0.5. FIG. 33 exemplifies the impact of opening the valve to trigger the rinsing operation on the CO₂ flow rate, with the current and the CO₂ supply being maintained while the rinsing operation was going on. In some implementations, the CO₂ flow can decrease when rinsing (due to increased pressure drop through the stack) and the cell voltage can also decrease while maintaining the same current (due to much increased hydrogen evolution activity). It should be further noted that even though the electroreduction can be maintained during the rinsing period, operation of the electrolyzer reactor can produce an increased amount of H₂ since the rinsing water may be blocking CO/CO₂ transport temporarily.

In other implementations, the CO/CO₂ gas feedline can be disconnected from the electrolyzer reactor during the rinsing period such that only rinsing water is fed to the cathodic compartment. The pump can thus be connected directly into the cathode inlet or outlet for rinsing. Once the rinsing operation is completed, the CO/CO₂ feedline can be connected again to resume normal operation.

The system can further include a controller for triggering the valve (e.g., controlled solenoid valve) and pump of the distribution assembly, such that the rinsing water is automatically pumped through the cathode inlet and out from the cathode outlet where it can then be directed to the collection tank or waste container.

In some implementations, the injection of the rinsing fluid can be performed with a ratio of flow rate to a volume of the cathodic compartment between 20 and 200 per minute, optionally between 50 and 80 per minute. The volume of interest here is the volume of the channels of the cathodic compartment (i.e. flow field).

The electroreduction system can be adapted to facilitate rinsing operation. For example, the cathodic compartment can include a porous support plate and the gas diffusion layer of the cathode can have pores which pore size is selected to avoid accumulation of rinsing fluid or salt-enriched fluid into the pores. The cathodic compartment can be as described in relation to the membrane electrode assembly described herein, the electrolyzer reactor described herein or the electrolyzer reactor stack described herein.

In some implementations, the method can include monitoring the pH and conductivity of the salt-enriched water to measure the effectiveness of the rinsing operation.

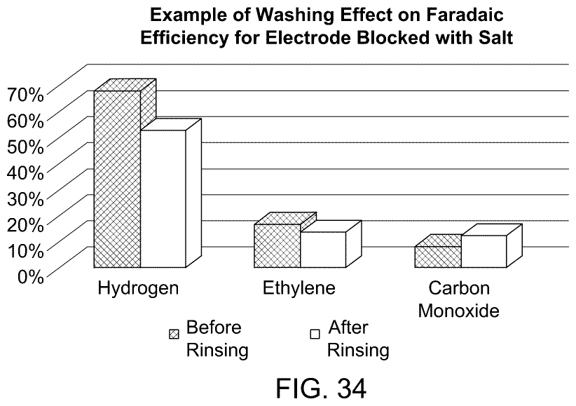

Referring to FIG. 34, it was shown that the rinsing operation successfully contributed to decreasing hydrogen production and increasing CO production due to an increase in CO₂ mass transport once the salt is rinsed away.

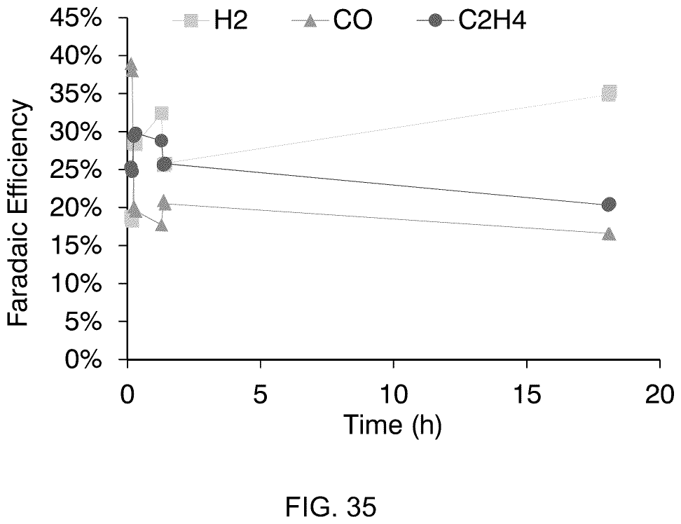

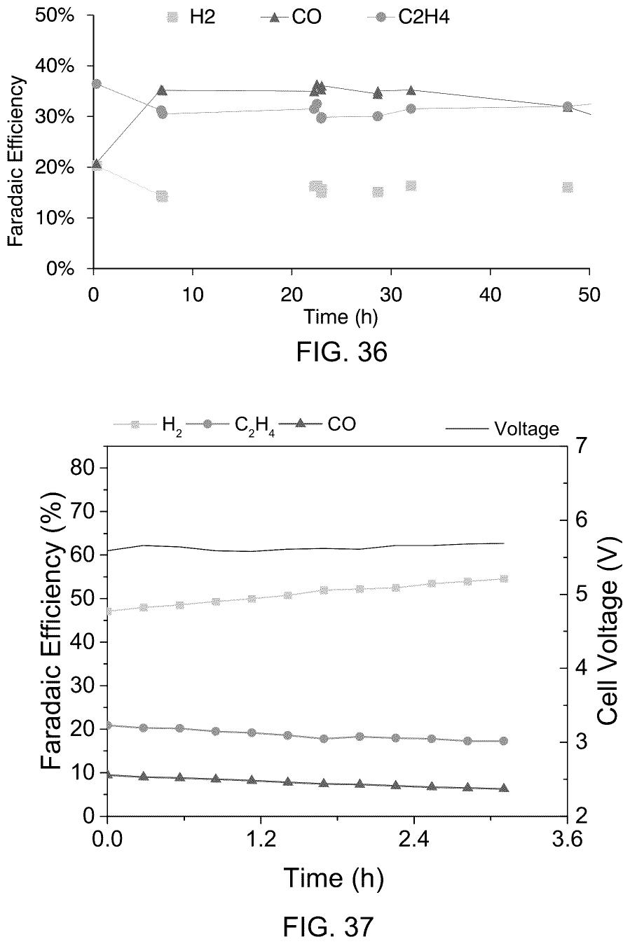

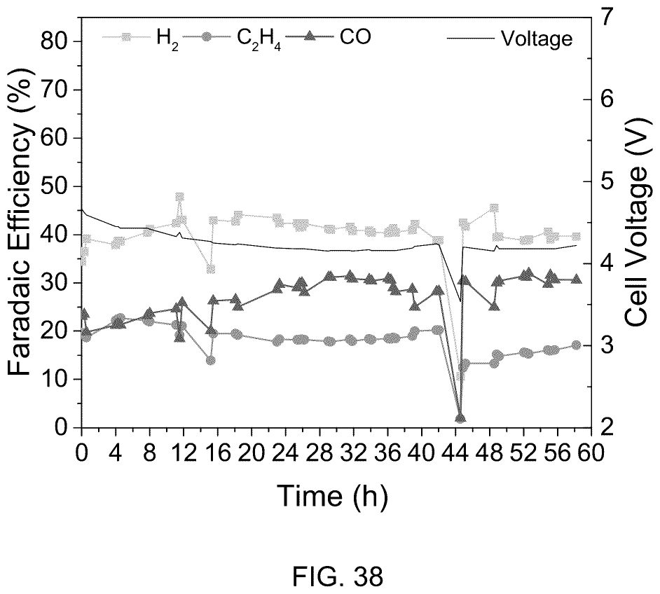

Comparing FIGS. 35 and 36, it was shown that without any rinsing operation the hydrogen production can increase quickly, whereas stability of the electrolyzer reactor is improved when performing a periodic rinsing of the cathodic compartment of the electrolyzer reactor. Regarding the effect of the rinsing frequency, and comparing FIGS. 37 and 38, it was shown that hydrogen production increased and electroreduction products decreased when the rinsing operation was not frequent enough.

It should be noted that the rinsing system can be adapted to any electrolyzer reactor, including the electrolyzer reactors as described herein and the electrolyzer reactor stack as described herein.

It should be noted that the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only. Therefore, the descriptions, examples, methods and materials presented in the claims and the specification are not to be construed as limiting but rather as illustrative only.

It is to be understood that where the specification states that a component, feature, structure, characteristic or step “can” or “could” be included, that particular component, feature, structure, characteristic or step is not required to be included.

Although the implementations of the electrolyzer stack reactor, membrane electrode assembly and gas diffusion electrode and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used, as can be easily inferred herefrom by a person skilled in the art. Moreover, it will be appreciated that positional descriptions such as “above”, “below”, “top”, “bottom”, “left”, “right” and the like should, unless otherwise indicated, be taken in the context of the figures and should not be considered limiting.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the present description, an implementation is an example. The various appearances of “some implementations” do not necessarily all refer to the same embodiment. Although various features of the present techniques and components may be described in the context of a single implementation, the features may also be provided separately or in any suitable combination. Conversely, although the present techniques and components may be described herein in the context of separate implementations for clarity, they may also be implemented in a single implementation.

1. A multiple-layer gas diffusion electrode (GDE) for sustaining electrochemical reduction of gaseous CO2, CO, or a combination thereof into multi-carbon products, the multiple-layer gas diffusion electrode comprising:
a gas diffusion layer (GDL) comprising:
a support layer;
a microporous layer (MPL) having pores that are sized to maintain the gaseous CO2, CO, or a combination thereof available for electroreduction; and
a catalytic layer comprising a catalyst favoring reduction of the CO2, CO or the combination thereof,
wherein each one of the support layer and the MPL is hydrophobic and electrically conductive, and the GDE being electrically conductive from one layer to another.

2. The multiple-layer GDE of claim 1, wherein the support layer comprises a first conductive material and a first hydrophobic polymer.

3. The multiple-layer GDE of claim 2, wherein the first conductive material is a carbon paper, a carbon felt, a carbon cloth, or a metal mesh.

4. (canceled)

5. The multiple-layer GDE of claim 2, where the support layer has a first hydrophobic polymer content between 5 wt % and 60 wt %.

6-8. (canceled)

9. The multiple-layer GDE of claim 1, wherein the MPL comprises a second conductive material and a second hydrophobic polymer.

10. (canceled)

11. The multiple-layer GDE of claim 9, wherein the second conductive material comprises porous particles.

12-13. (canceled)

14. The multiple-layer GDE of claim 9, wherein the MPL has a second hydrophobic polymer content between 60 wt % and 99 wt %.

15-17. (canceled)

18. The multiple-layer GDE of claim 1, wherein the catalyst is provided as particles, and the catalytic layer further comprises a binder that binds the catalyst particles, and facilitates ionic conductivity and CO2 availability to the catalyst particles.

19-21. (canceled)

22. The multiple-layer GDE of claim 18, wherein the catalyst particles are nanoparticles.

23-25. (canceled)

26. The multiple-layer GDE of claim 1, further comprising a stabilization layer comprising solid particles having a surface that is modified with a functionalizing group to prevent the catalytic layer from reconstructing during operation of the multiple-layer gas diffusion electrode.

27-29. (canceled)

30. The multiple-layer GDE of claim 26, wherein the functionalizing group is an ionized unit, imidazolium, sulfonic acid, poly(aryl piperidinium) of an ion-conducting ionomer.

31-32. (canceled)

33. A method for producing a gas diffusion electrode (GDE) comprising a gas diffusion layer (GDL) and a catalytic layer, the method comprising:
providing a hydrophobic and conductive support layer;
blade coating a microporous layer ink on the support layer, the microporous layer ink comprising conductive particles and a hydrophobic polymer to form a microporous layer (MPL);
heat treating the MPL to sinter the hydrophobic polymer within a network of the conductive particles and form the GDL;
spraying a catalyst ink comprising catalyst particles and a binder onto the GDL to form the catalytic layer.

34-37. (canceled)

38. The method of claim 33, wherein the GDE further comprises a stabilization layer comprising solid particles having a surface that is modified with a functionalizing group, and the method further comprising spraying a stabilization ink comprising the solid particles and a binder onto the catalytic layer.

39. (canceled)

40. The method of claim 38, wherein the solid particles are carbon nanoparticles and the binder is an ion-conducting polymer.

41-55. (canceled)

56. A reactor for operating electroreduction of CO2, CO, or a mixture thereof into carbon products, the reactor comprising:
a membrane electrode assembly comprising:
a cathode being a multiple-layer gas diffusion electrode (GDE) as defined in claim 1, an anode, and
an ion exchange membrane; and
a support structure comprising a pair of opposed support substructures, each support substructure contacting one side of the membrane electrode assembly to uniformly maintain the membrane electrode assembly in between the pair of opposed support substructures;
wherein each support substructure comprises at least one layer of a porous and electrically conductive material to ensure flow of reactants, products, electrolyte and electrons to or from the anode and the cathode of the membrane electrode assembly.

57. The reactor of claim 56, wherein each support substructure is welded to, adhered to, fastened to, hot-pressed or pressed against the cathode or the anode of the membrane electrode assembly.

58. The reactor of claim 56, wherein the porous and electrically conductive material comprises titanium, copper, aluminum, stainless steel, bronze, brass, galvanized steel, platinum, nickel, carbon, carbon steel, iron, lead or any combinations thereof.

59. The reactor of claim 56, wherein the porous and electrically conductive material is a metal that avoids catalyzing hydrogen evolution reaction (HER).

60. The reactor of claim 56, wherein the porous and electrically conductive material is a metal that avoids catalyzing hydrogen evolution reaction (HER), that is resistant to corrosion or that is resistant to hydrogen embrittlement.

61-62. (canceled)

63. The reactor of claim 56, wherein the support substructure in contact with the cathode of the membrane electrode assembly is the cathodic support substructure, the cathodic support substructure consisting of a single layer of the porous and electrically conductive material.

64-65. (canceled)

66. The reactor of claim 63, wherein the single layer of the cathodic support substructure has pores having a pore size ranging between 1 mm and 10 mm.

67. (canceled)

68. The reactor of claim 56, wherein the support substructure in contact with the anode of the membrane electrode assembly is the anodic support substructure, the anodic support substructure consisting of multiple layers of a porous, electrically conductive and anti-corrosive material.

69-73. (canceled)

74. The reactor of claim 68, wherein each layer of the anodic support substructure has pores having a pore size ranging between 1 mm and 10 mm.

75. The reactor of claim 56, wherein the support structure further comprises a turbulence enhancer that is added to at least one of the support substructures.

76-123. (canceled)
